(19) United States
(12) Patent Application Publication
(10) Pub. No.: US 2014/0286316 A1
(43) Pub. Date: Sep. 25, 2014

(54) APPARATUS AND METHOD FOR CONTROLLING SELECTIVE USE OF HETEROGENEOUS NETWORKS ACCORDING TO UNPROCESSED STATE OF DATA BEING STREAMED

(71) Applicant: AIRPLUG INC., Seoul (KR)

(72) Inventors: Jin Soo Park, Seoul (KR); Jun Seok Song, Seoul (KR)

(73) Assignee: AIRPLUG INC., Seoul (KR)

(21) Appl. No.: 14/348,410

(22) PCT Filed: Sep. 26, 2012
(86) PCT No.: PCT/KR2012/007756

§ 371 Date: Mar. 28, 2014

(30) Foreign Application Priority Data
Oct. 6, 2011 (KR) 10=2011=0102055

(51) Int. Cl. H04W 36/22

(52) U.S. Cl. CPC H04W 36/22
USPC 370/332

(57) ABSTRACT

An entity executed in a wireless communication terminal according to the present invention transmits a series of requests to an external server through a first and a second communication network so that selected content can be received being divided between the two communication networks, receives data segments of the selected content transmitted through the two communication networks from the external server according to the series of requests and provides the received data segments to a processing unit intended for playing of content data in order of the data segments, and checks the amount of unprocessed data not yet provided. If the amount of unprocessed data is larger than a predetermined reference value, the entity transmits a series of requests demanding data of the selected content only to the second communication network which is more advantageous for a user form the aspect of cost in using a data service.

### TECHNICAL FIELD

The present invention is related to an apparatus which enables to use a plurality of heterogeneous networks selectively, each of which providing a service region with different characteristics from each other or providing service quality differing from the others and a method for the apparatus.

### BACKGROUND ART

As mobile communication networks are advanced, users are now able to access various kinds of information for their needs through browsing or enjoy desired contents through downloading or streaming the contents regardless of their current location by using their smart phone, table computer, and the like, not to mention a mobile phone (in what follows, it is called collectively a “wireless communication terminal”).

A wireless communication terminal capable of receiving location-independent data services always maintains a state of being connected to one of a plurality of heterogeneous networks which rely on different infrastructures from each other and can be accessed through wireless communication resources of the terminal, namely a state in which data communication is possible by receiving a connection IP address.

For example, if a communication network such as a Wi-Fi LAN network providing high-speed wireless data services is currently available, the wireless communication terminal maintains a state of being connected to the communication network; otherwise, the wireless communication terminal receives a connection IP address from a mobile phone network such as CDMA2000 or W-CDMA network covering a broad service area and maintains a connected state for data services thereto. Furthermore, in case the two different types of communication networks are both available, the wireless communication terminal maintains a state of being connected to the Wi-Fi wireless LAN network, which usually provides high-speed data access, unless access to the Wi-Fi wireless LAN network is deliberately suppressed by other reasons. Thus the wireless communication terminal always maintains a connected state to a single communication network for receiving data services.

Since a Wi-Fi wireless LAN network is available only in a scattered, local service area, however, the users have no choice but to use data services under a condition that consistency or continuity of the data services is not always guaranteed. Therefore, most of the users of wireless communication terminals use data services based on a mobile phone network supporting a broad service area; since a data service through the mobile phone network is charged on the basis of data usage, however, the users tend to use the Wi-Fi wireless LAN network as much as possible while the Wi-Fi wireless LAN network is available.

In such a communication environment, if a Wi-Fi wireless LAN network becomes available while the user is watching streaming contents provided from an arbitrary server by using his or her wireless communication terminal connected to a mobile phone network, the user may attempt connection switching to the Wi-Fi wireless LAN network for fear of or from concern about the cost incurred due to the amount of streaming data. If the connection switching is carried out, however, the connection IP allocated to the wireless communication terminal is changed; thus, the user has to perform a tricky procedure of requesting the streaming contents again, specifying the last part that the user has watched and playing the contents from the specified part.

Moreover, even if the user takes the trouble to perform such a tricky procedure making the same contents stream through the Wi-Fi wireless LAN network, there is always the chance that the radio condition of an Access Point (AP) through which the wireless communication terminal is connected to the Wi-Fi wireless LAN network may not be good enough to ensure a required communication speed, for example, due to weak signal strength or heavy traffic. In this case, the wireless communication terminal needs to be connected to the mobile phone network again; in case the wireless communication terminal leaves the narrow service area of the Wi-Fi wireless LAN network, too, re-connection to the mobile phone network is required. At this time, therefore, the user has to perform again the tricky procedure applied for the player to watch the same contents seamlessly.

### DISCLOSURE

### Technical Problem

One object of the present invention is to provide a method and apparatus for enabling seamless and continuous play while receiving streaming data by a selective use or joint use of heterogeneous networks available.

Another object of the present invention is to provide a method and apparatus for controlling usage of a communication network to receive streaming data by taking account of the cost incurred as the user uses the communication network.

A yet another object of the present invention is to provide a method and apparatus for suppressing the cost of using a data service as much as possible while ensuring seamless play of contents by adjusting conditions for changing a method for using communication networks adaptively according to a current situation.

The scope of the present invention is not necessarily limited to the above explicit statements. Rather, the scope of the present invention covers anything to accomplish effects that could be derived from the specific and illustrative explanations of the present invention below.

### Technical Solution

A wireless communication terminal capable of accessing to a plurality of networks in accordance with one aspect of the present invention, comprises: a channel builder adapted to configure a data channel for providing content data to a processing unit intended for decoding content data; and a data transceiver adapted to (1) transmit a series of requests to an external server through a plurality of heterogeneous networks including at least a first communication network and a second communication network so that a selected content can be received being divided among the plurality of heterogeneous networks, (2) receive data of segments of the selected content transmitted through the plurality of heterogeneous networks by the external server according to the series of requests, (3) check amount of unprocessed data, not yet provided to the processing unit, in the data channel while providing the received data through the data channel for the processing unit to use the received data in order of segments, and (4) transmit a series of requests demanding data of the selected content through a communication network excluding the first communication network if the checked amount of unprocessed data is equal to or greater than a predetermined first reference value, wherein the second communication network requires no cost to a user using a data service or a smaller cost, excluding fixed cost, than the first communication network.

In the wireless communication terminal, the data transceiver may be further adapted to: check the amount of unprocessed data while receiving data of segments transmitted only through the second communication network from the external server by transmitting a series of requests demanding data of the selected content only through the second communication network, and providing the received data to the processing unit through the data channel; and transmit a series of requests demanding data of the selected content also through the first communication network if the checked amount of unprocessed data is equal to or smaller than a predetermined second reference value that is set to be smaller than the first reference value.

In one embodiment of the present invention, the data transceiver is further adapted to: check whether use of the first communication network is permitted if the checked amount of unprocessed data is equal to or smaller than the second reference value; and transmit a series of requests demanding data of the selected content also through the first communication network only if use of the first communication network is permitted. In addition, the data transceiver may check permission to use the first communication network based on at least one of: a value obtained from inter-computation of remaining days on period of a rate schedule and amount of remaining data unused from a default amount of data; a comparison result between size of the selected content and a predetermined size limit; information within environmental information set up by a user indicating whether use of the first communication network is permitted; and a permission control value received in response to an inquiry to a user.

In on embodiment of the present invention, the data transceiver is adapted to transmit a series of requests demanding data of the selected content also through the first communication network in case the amount of unprocessed data is equal to or smaller than the second reference value and the second communication network is not in a good communication state. Whether the second communication network is in a bad or a good communication state is determined based on whether the amount of unprocessed data is decreasing or not.

In one embodiment of the present invention, the data transceiver is further adapted to set both of the first and the second reference values to be greater respectively than that set in a standard mode if a mode for restraining incurrence of costs is currently set, and set both of the first and the second reference values to be smaller respectively than that set in the standard mode if a mode for prioritizing convenience in using a data service is currently set. In the present embodiment, the wireless communication terminal may further comprises a mode determining unit adapted to automatically determine the mode based on data usage with respect to the first communication network, rate schedule information of a user, and remaining days in terms of a rate schedule period.

In one embodiment of the present invention, the data transceiver is further adapted to adjust the first and the second reference values to a smaller one respectively if a receiving speed of data through the second communication network is higher than an arbitrary reference speed, and adjust the first and the second reference values to a greater one respectively if the receiving speed is lower than the arbitrary reference speed.

In one embodiment of the present invention, the data transceiver is further adapted to adjust the first and the second reference values to a greater one respectively if a communication characteristic of the second communication network changes larger than an arbitrary reference amount wherein the communication characteristic may correspond to at least one of a signal strength and a data receiving speed from an access point of the second communication network.

In one embodiment of the present invention, the data transceiver is further adapted to adjust the first and the second reference values to a smaller one respectively if amount of unreceived data of the selected content is below an arbitrary reference value.

In one embodiment of the present invention, the data transceiver is further adapted to adjust the first and the second reference values to a greater one respectively if request for a data segment belonging to a particular section specified with respect to the selected content is made to the external server. The particular section may be a section including at least one of a segment requiring increase of bandwidth, a segment designated to have a high viewer preference, and a segment into which an additional content has been inserted. In the present embodiment, the particular section can be identified by information specified in media description information related to the selected content, the media description information being received in response to a request for the selected content made before the series of requests. In another way, it can be identified by information specified in description information about a part of the selected content, the description information being received while the series of requests are transmitted.

In one embodiment of the present invention, the data transceiver is further adapted to adjust the first reference value to a greater one if a decrease rate of the amount of unprocessed data is higher than an arbitrary reference rate, and adjust the first reference value to a smaller one if the decrease rate is lower than the arbitrary reference rate.

In one embodiment of the present invention, the data transceiver is further adapted to transmit a series of requests demanding data of the selected content through a communication network excluding the first communication network if amount of unreceived data of the selected content is below an arbitrary reference value.

In one embodiment of the present invention, the data transceiver is further adapted to transmit a series of requests demanding data of the selected content through a communication network excluding the first communication network in case an additional condition is met, the additional condition including that the amount of unprocessed data is equal to or greater than the first reference value and the amount of unprocessed data is increasing. The additional condition further includes that the first communication network has a reluctance factor to be used wherein the reluctance factor includes a cost for future use of a communication network.

In one embodiment of the present invention, the data transceiver is further adapted to transmit the series of requests through a plurality of communication sockets and store information indicating an order of a data segment demanded by each request in association with a communication socket which the each request has transmitted through.

In one embodiment of the present invention, the processing unit is adapted to read out content data, provided to the data channel, at a speed corresponding to a required bit rate determined from size and playtime of the content data.

In one embodiment of the present invention, the amount of unprocessed data corresponds to a size of the unprocessed data, and the first and the second reference values are set respectively in terms of amount of time, and the data transceiver is further adapted to calculate amount of data corresponding to the first or the second reference value by multiplying a bit rate required for playing the content data with the amount of time.

In one embodiment of the present invention, the amount of unprocessed data corresponds to play time of the unprocessed data.

In one embodiment of the present invention, the data transceiver is adapted to treat all of data remained, not provided to the processing unit, in the data channel as the amount of unprocessed data.

In one embodiment of the present invention, the data transceiver is adapted to treat amount of particular data among the data remained, not provided to the processing unit, in the data channel as the amount of unprocessed data, the particular data being playable seamlessly without discontinuity subsequent to a current play time.

In one embodiment of the present invention, the data transceiver is adapted to make data segments of the selected content be received being divided between the first communication network and the second communication network as dividing the selected content into data segments and transmitting a series of requests specifying individual segments.

In another embodiment of the present invention, the data transceiver is adapted to make data segments of the selected content be received being divided between the first communication network and the second communication network as conducting an operation that transmits a series of requests specifying individual transmission starting positions of the selected content and an operation that stops data receiving from a transmission starting position specified in a next request with respect to each of the series of requests.

In one embodiment of the present invention, the data transceiver is adapted to cause the processing unit to use the received data of segments in order of segments by storing the received data in the data channel or transmitting the received data through the data channel in order of segments.

In another embodiment of the present invention, the data transceiver is adapted to cause the processing unit to use the received data of segments in order of segments based on order information of each of the segments by storing the received data in the data channel or transmitting the received data through the data channel along with the order information.

In one embodiment of the present invention, the processing unit is adapted to include a media data processing unit for decoding data of each segment of a content retrieved or received from the data channel, or for causing the data of the each segment to be decoded.

A method of controlling selective use of communication networks based on unprocessed state of data in accordance with another aspect of the present invention, comprises: transmitting a series of requests to an external server through a plurality of heterogeneous networks including at least a first communication network and a second communication network so that a selected content can be received being divided among the plurality of heterogeneous networks; receiving data of segments of the selected content transmitted through the plurality of heterogeneous network by the external server according to the series of requests, and providing the received data through a data channel so that a processing unit intended for decoding content data can use the received data in an order of segments; and checking amount of unprocessed data, not yet provided to the processing unit, in the data channel and transmitting a series of requests demanding data of the selected content through a communication network excluding the first communication network if the checked amount of unprocessed data is equal to or greater than a predetermined first reference value, wherein the second communication network requires no cost to a user using a data service or a smaller cost, excluding fixed cost, than the first communication network.

In addition, the method may further comprises: receiving data of segments transmitted only through the second communication network from the external server by transmitting a series of requests demanding data of the selected content only through the second communication network, and providing the received data to the processing unit through the data channel; and checking the amount of unprocessed data and transmitting a series of requests demanding data of the selected content also through the first communication network if the checked amount of unprocessed data is equal to or smaller than a predetermined second reference value.

In one embodiment of the present invention, the checking the amount of unprocessed data is carried out before each of the series of requests is transmitted.

An apparatus equipped with a storage storing for programs to be provided through a network in accordance with another aspect of the present invention, comprises: communication means being capable of transceiving data through communication with an outside entity; and storing means storing an application to be run on a wireless communication terminal, the application being transmitted through the communication means, wherein the application includes a program structure to accomplish operations, in case of being run on the wireless communication terminal, that comprise: configuring a data channel; transmitting a series of requests to an external server through a plurality of heterogeneous networks including at least a first communication network and a second communication network so that a selected content can be received being divided among the plurality of heterogeneous networks; receiving data of segments transmitted through the plurality of heterogeneous network from the external server according to the series of requests, and transmitting the received data through the configured data channel so that a processing unit intended for decoding content data can use the received data in order of segments; and checking amount of unprocessed data, not yet provided to the processing unit, in the data channel and transmitting a series of requests demanding data of the selected content through a communication network excluding the first communication network if the checked amount of unprocessed data is equal to or greater than a predetermined first reference value, wherein the second communication network requires no cost to a user using a data service or a smaller cost, excluding fixed cost, than the first communication network.

In addition, the application may further include another program structure to accomplish operations, in case of being run on the wireless communication terminal, that comprise: receiving data of segments transmitted only through the second communication network from the external server by transmitting a series of requests demanding data of the selected content only through the second communication network, and providing the received data to the processing unit through the data channel; and checking the amount of unprocessed data, not provided to the processing unit, in the data channel and transmitting a series of requests demanding data of the selected content also through the first communication network if the checked amount of unprocessed data is equal to or smaller than a predetermined second reference value.

In one embodiment of the present invention, the application may further include another program structure to accomplish an operation, in case of being run on the wireless communication terminal, that comprises decoding data of each segment of a content retrieved or received from the data channel, or causing the data of the each segment to be decoded.

### Advantageous Effects

The present invention described above or at least one embodiment of the present invention described in detail below with reference to appended drawings ensures seamless and continuous play of content data in the middle of receiving and playing the content data by using a communication network incurring zero cost or smallest cost of using the content data if the amount of received content data is sufficient or by further incorporating a mobile phone network exhibiting relatively high service stability if the amount of received content data is expected to be insufficient to ensure continuity of playing the content data.

Therefore, according to the present invention, the user who plays and watches content data through a wireless communication terminal can fully enjoy watching the content without experiencing disconnection of the content data while minimizing the cost of using the content data.

Also, the present invention proposes or maintains using a plurality of communication networks adaptively in response to an anticipated increase of bandwidth to handle accompanying information or media data, thereby enabling the user to check additional information without causing inconvenience in watching content and leading to satisfaction for both of the user and provider of the content.

### DESCRIPTION OF DRAWINGS

FIG. 1 illustrates a logical structure of constituting elements of a wireless communication terminal according to the present invention in which an embodiment of a method for controlling a selective use of available heterogeneous networks according to a buffering state of data is implemented and their connection to external entities as seen from the programming point of view;

FIG. 2 illustrates a structure of a wireless communication terminal according to one embodiment of the present invention in which one method for receiving media data while controlling a selective use of heterogeneous networks depending on an unprocessed state of data is implemented;

FIG. 3 illustrates a structure of a media player receiving and decoding media data while controlling a selective use of heterogeneous networks by taking account of an unprocessed state of data according to one embodiment of the present invention, together with part of related constituting elements of a wireless communication terminal;

FIG. 4 illustrates a process of dividing content data appropriately into data segments and generating documents demanding the respective segments in compliance with communication specifications to receive selected content data while using heterogeneous networks selectively according to one embodiment of the present invention;

FIG. 5 illustrates a process of recording information needed to arrange data segments in order at the time of requesting and receiving the respective segments through a plurality of communication sockets in a distributed manner in association with the corresponding communication sockets according to one embodiment of the present invention;

FIG. 6 illustrates an example of considering only the continuous data sections among received data to check the amount of unprocessed data according to one embodiment of the present invention;

FIG. 7 is a flow diagram illustrating one method according to one embodiment of the present invention for carrying out a selective use of communication networks when a single type of a communication network is employed;

FIG. 8 is a flow diagram illustrating one method according to one embodiment of the present invention for carrying out a selective use of communication networks when different types of communication networks are used together;

FIG. 9 illustrates a process according to one embodiment of the present invention, where data of selected content is divided into separate segments and documents demanding the respective segments are transmitted through communication sockets generated for the respective communication networks;

FIG. 10 illustrates an operation carried out for receiving unreceived part of a data segment requested previously through a different communication network in the middle of switching from using a single communication network to a joint use of communication networks according to one embodiment of the present invention;

FIGS. 11 and 12 illustrate examples according to one embodiment of the present invention where, regarding a data segment requested previously on the communication network supposed not to be used after a process of switching from a joint use of different communication networks to the use of a single communication network, the data segment is requested again through a communication socket generated for the other communication network depending on reception of current data of the corresponding segment;

FIG. 13 illustrates a process for receiving data segments, for which data reception has been suspended, from the other communication network according to one embodiment of the present invention as one of the communication networks is rendered unavailable during a joint use of the communication networks;

FIG. 14 illustrates a process for receiving content data in the form of data segments by transmitting documents specifying only the start positions of the data segments according to another embodiment of the present invention;

FIG. 15 illustrates an example of a structure of a shared memory according to another embodiment of the present invention, where segments of content data are stored in the order by which the segments are received and each segment is provided according to a section order of the content data for the purpose of decoding;

FIG. 16 illustrates an example where reference values meant for selecting a method for using communication networks are configured differently by various modes determined by taking account of the cost and persistency of using a data service according to one embodiment of the present invention;

FIG. 17 illustrates a mode determined by an external entity and constituting elements related to a media player using the determined mode according to one embodiment of the present invention;

FIG. 18 illustrates a range of the amount of remaining data that can be adjusted on the basis of the amount of unreceived data of the content for which a reference value meant for selecting a method for using communication networks has been determined according to one embodiment of the present invention; and

FIG. 19 illustrates an example according to another embodiment of the present invention where constituting elements controlling a selective use of heterogeneous networks based on an unprocessed state of data are employed as independent entities separately from a player decoding media data.

### MODE FOR INVENTION

In what follows, embodiments of the present invention will be described in detail with reference to appended drawings.

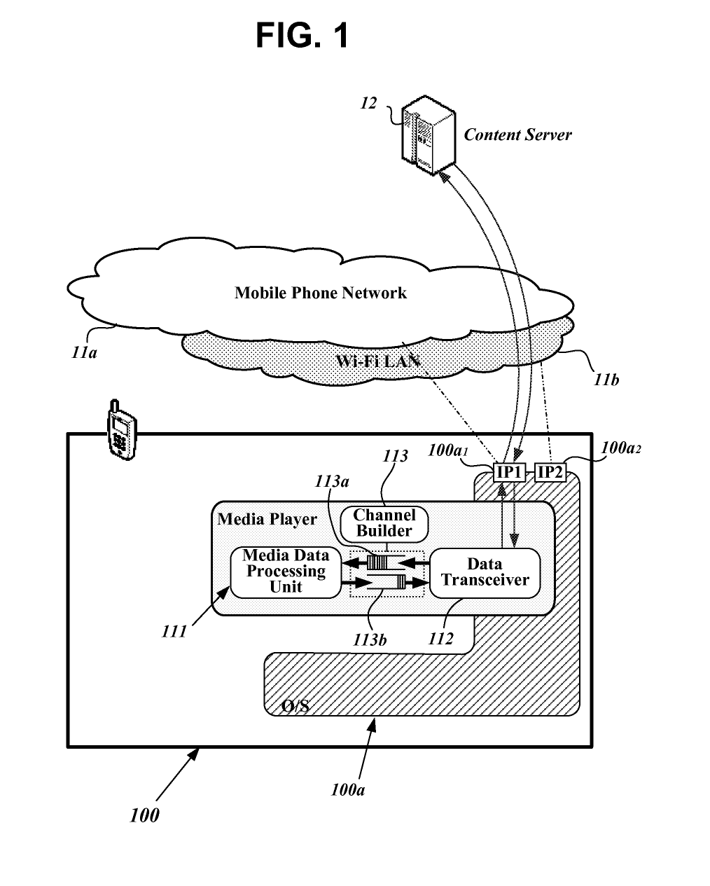

FIG. 1 illustrates a logical structure of constituting elements of a wireless communication terminal according to the present invention in which an embodiment of a method for controlling a selective use of available heterogeneous networks according to an unprocessed state of data is implemented and their connection to external entities as seen from the programming point of view. Here, the phrase of “selective use” refers to the case of using all of a plurality of heterogeneous networks or the case of selecting one or more networks from among the plurality of networks and using the selected network partially, which is used in the same context in the remainder of this document.

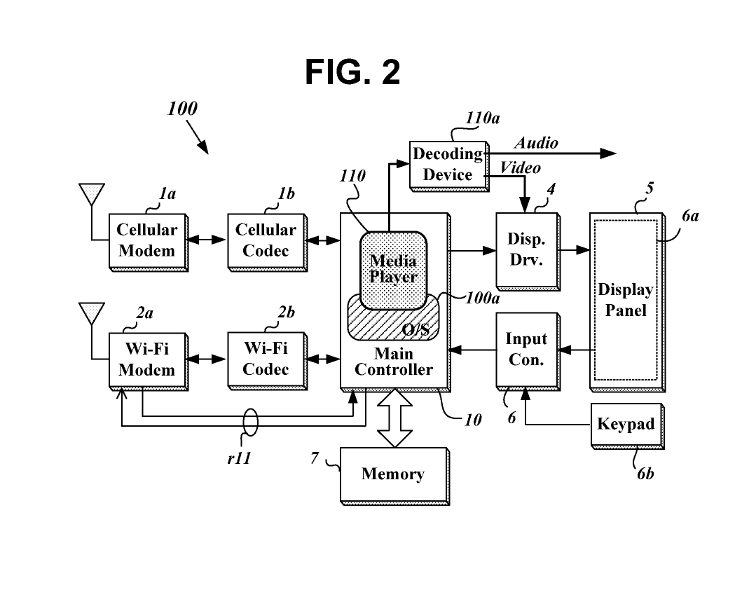

The logical structure of the wireless communication terminal 100 from the programming point of view as illustrated in the figure comprises a conventional operating system such as Android, IOS, and Windows intended for driving hardware resources (illustrated in FIG. 2) of the wireless communication terminal 100 and exchanging appropriate signals and/or information with the corresponding resources or an operating system 100a specific to the present invention; and a media player 110 executed under the operating system 100a. Besides the media player 110, various applications can be implemented under the operating system 100a; however, since they are not necessary to describe the technical principles and scope of the present invention, conventional applications (hereinafter, they are called “applications” for short) will not be described. The operating system 100a can obtain connection IP addresses for data services from wireless communication networks which can be utilized as hardware resources of the wireless communication terminal 100 and use the obtained addresses jointly. FIG. 1 illustrates a situation where the operating system 100a receives IP1 100a₁ from a mobile phone network 11a and IP2 100a2 from a Wi-Fi wireless LAN network 11b and configures the wireless communication terminal 100 with the obtained addresses. Depending on the needs, the operating system 100a may be configured with a single connection IP address.

The media player 110 in the figure is a process or an application implemented in the wireless communication terminal 100, which can be provided in the form of software having a structure comprising program codes executed under the operating system 100a as shown in FIG. 1. In case the media player 110 is provided in the form of software, the media player 110 stored in a high-capacity storage means of a particular server may be downloaded and executed in the wireless communication terminal 100 through a conventional on-line purchasing process from the particular server connected to a communication network. Depending on situations, part of functions described in detail below can be implemented in the form of middleware or in the form of a platform for the terminal. Also, by incorporating a hardware component, the media player 110 can perform part of the functions described in detail below through the hardware component. Therefore, the technical scope of the present invention is not limited by the resources employed for implementation of the media player 110, the structure and operating method of which are described in detail through various embodiments according to the present invention.

In one embodiment according to the present invention, the media player 110 comprises a media data processing unit 111 which decodes media data of received content; and a data transceiver 112 generating a communication socket through an API (Application Program Interface) provided by the operating system 100a and communicating data exchanged to and from the media data processing unit 111 with the external entities through the generated communication socket as a sub-process. The media player 111 further comprises a channel builder 113 which allocates or generates a receiving buffer 113a and transmission buffer 113b used as a data channel for data transmission or exchange between the media data processing unit 111 and the data transceiver 112. In another embodiment according to the present invention, the transmission buffer may not be employed. In the present embodiment, the media data processing unit 111 provides the data transceiver 112 with data or requests to be transmitted to an external server according to the user's request through parameterization, and the data transceiver 112, in accordance with the parameterization, generates a request in compliance with communication specifications, for example, HTTP Request and transmits the generated request. In another embodiment according to the present invention, a UI processing unit intended for a function of processing user requests can be implemented as an independent process separately from the media data processing unit 111. In the present embodiment, the UI processing unit provides the data transceiver 112 with data or requests to be transmitted to an external server according to the user's request through parameterization.

The data transceiver 112 identifies a communication network that can be accessed among a plurality of available heterogeneous networks 11a, 11b through the operating system 110a and communicates data with an external server 12 by using a communication network relevant to an operating condition. Also, to perform data buffering seamlessly in the receiving buffer 113a so that continuity of content being played can be ensured even in the middle of changing a method for using communication networks, for example, between the use of a single communication network and a joint use of multiple communication networks, the data transceiver 112 performs the operation of generating a request in compliance with required communication specifications, for example, a HTTP Request for each segment of media data and transmitting the data segments by distributing them among communication networks or transmitting the data segments by concentrating them in a single communication network. Such an operation of the data transceiver 112 will be described in detail below. And the media data processing unit 111 can also generate a request in compliance with communication specifications according to the user's request and delivers the generated request to the data transceiver 112 through the transmission buffer 113b, thereby transmitting the generated request to the external server 12.

In one embodiment according to the present invention, the data transceiver 112, media data processing unit 111, and channel builder 113 can be implemented together as a single process run under the operating system 100a. In this case, exchange of information or data among them can be carried out by using global variables, local variables, or arguments and/or return values of local functions. Therefore, the technical principles, scope, and expectations of the present invention do not necessarily presume or require that the data transceiver 112, media data processing unit 111, and channel builder 113 have to be separated from each other and implemented as separate processes, but the technical principles, scope, and expectations can also be realized even when individual functions described below are implemented by a single process.

The wireless communication terminal 100 having a logical structure of FIG. 1 generally comprises such hardware components as shown in FIG. 2 and can represent any one of a smart phone capable of accessing both of a public mobile phone network and a high-speed wireless data network, tablet computer, and a notebook computer equipped with a function of a mobile phone. To provide specific descriptions of the block diagram in the figure, the wireless communication terminal 100 comprises a cellular modem 1a (which is a constituting element including a module processing RF signals) communicating with a cellular network by modulating or demodulating a signal according to a predetermined method employed for a public mobile phone network, for example, a 2G, 3G, or 4G cellular network (hereinafter, it is called collectively “cellular network”); a cellular codec 1b encoding data or decoding encoded data according to communication specifications employed for the cellular network; a Wi-Fi modem 2a (which is a constituting element including a module processing RF signals) communicating with a high-speed wireless data network, for example, a Wi-Fi wireless LAN network by modulating or demodulating signals according to a predetermined method employed for the wireless data network; a Wi-Fi codec 2b encoding data or decoding encoded data according to communication specifications employed for the wireless data network; a display panel 5 for visual display of an image, characters, and so on; a display driving unit 4 driving the display panel 5 for arbitrary data to be displayed visually on the display panel 5; a decoder 110a decoding input encoded image and audio data and outputting the decoded image and audio data as image and audio signals; a touch sensor 6a attached at the front of the display panel 5; a keypad 6b equipped with keys and/or buttons; an input control unit 6 sensing a user input and/or selection applied to the touch sensor 6a and keypad 6b and outputting input information in accordance with the sensing result; a main controller 10 communicating data with the constituting elements or controlling them to carry out operation according to input information from the input control unit 6 or controlling the display driving unit 4 for display of a user interface (UI) intended for receiving the user's selection; and a memory 7 providing data storage space required for operation of the main controller 10.

And the main controller 10 enables the operating system 100a to perform intended functions by executing given command codes and also by executing command codes of the media player 110, enables the media player 110 to carry out operations to be described in detail below. In particular, the media data processing unit 111 of the media player 110, if needed, can apply the decoding operation performed in hardware by the decoder 110a to encoded image or audio data blocks through an appropriate API (Application Program Interface) provided by the operating system 100a.

The structure of the wireless communication terminal 100 illustrated in FIG. 2 is only an example intended to describe embodiments of the present invention in a specific and illustrative manner to help understand the technical principles and scope of the present invention. Mobile terminals implementing the technical principles of the present invention can further include constituting elements providing various functions not shown in FIG. 2 or exclude constituting elements illustrated and moreover, hardware elements can be implemented by software and vice versa.

In what follows, described will be a process of receiving content data and changing a method for using communication networks while receiving content data is carried out in the wireless communication terminal 100, the logical structure of which is illustrated in FIG. 1 with respect to the media player 110.

First of all, the user activates a browser through an appropriate user interface (UI) provided by the main controller 10, where the user interface is implemented in an input and output unit (for example, the display panel 5, touch sensor 6a, keypad 6b, and so on) installed in the wireless communication terminal 100. If the user selects one content provided by a particular server, for example, the content server 12 illustrated in the figure and requests the content through the browser, a request compliant with communication specifications according to the user request (for example, an HTTP Request for the URL of “http://vod.airplug.com/vd/vABC.mp4”) is sent to the operating system 100a. The operating system 100a then transmits the received request compliant with communication specifications through hardware resources (the cellular codec 1b and cellular modem 1a or the Wi-Fi codec 2b and Wi-Fi modem 2a) to support a communication network designated for use by default in case the wireless communication terminal 100 is connected to multiple communication networks (in other words, in case multiple connection IP addresses (IP1, IP2) are assigned to the terminal as shown in FIG. 1); or through hardware resources designated for a particular communication network if the wireless communication terminal 100 is connected to the communication network. Accordingly, if a response from the content server 12, for example, data related to the selected content is duly received through a requested communication network, the response is provided to the browser.

The response received by the browser includes information such as file description information provided differently according to a protocol format, for example, MIME (Multipurpose Internet Mail Extensions) type and overall size of the content data in addition to the content data transmitted by the content server 12. Therefore, the browser activates the media player 110, an application associated with the MIME type of the received response. The association of the media player 110 can also be made by the file extension rather than the MIME type. The browser, activating the media player 110, delivers the URL which has caused the response or a request compliant with communication specifications generated according to the URL, for example, an HTTP Request or RTSP/RTP Request to the media player 110 as a calling argument.

Up to this point, it has been assumed that the process of activating the media player 110 is carried out through a browser commonly used. It should be noted, however, that the media player 110 can be activated by various applications in addition to the browser. In other words, if access information about particular content, for example, URL is selected while an arbitrary application is running, the application can activate the media player 110 by carrying out the same process as done by the aforementioned browser.

In other case, the media player 110 can be activated without involving a parameterized URL or a request compliant with communication specifications; a URL can be received or selected directly through the user interface. Then the data transceiver 112 is notified of the URL received or selected directly or a request compliant with communication specifications according to the URL.

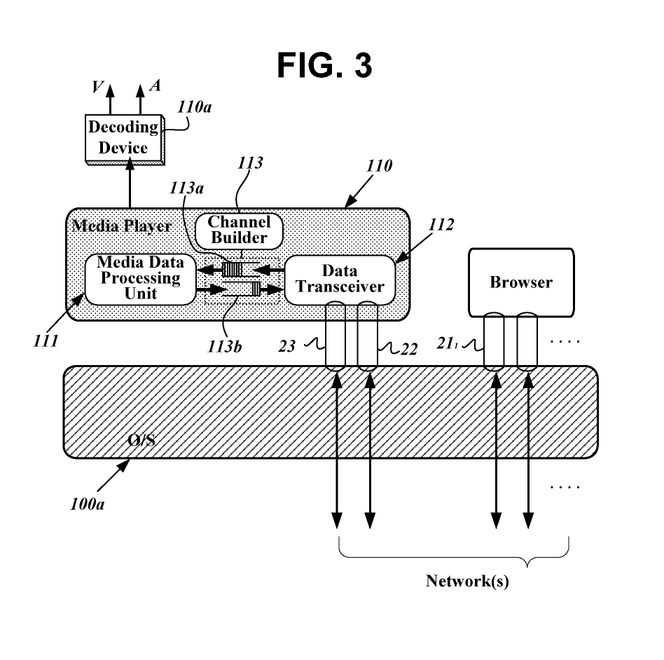

Once the media player 110 is activated, the channel builder 113 allocates the receiving buffer 113a and transmission buffer 113b to the memory 7, and each of the allocated buffers 113a, 113b is shared with the media data processing unit 111 and the data transceiver 112. The data transceiver 112 is notified of the received calling argument; as shown in FIG. 3, while providing the notified calling argument, namely a request compliant with communication specifications, the data transceiver 112 requests the operating system 100a to generate a new communication socket 22. At this time, the request can be handled in a communication network designated for data services by default or in a particular communication network. To specify a communication network, the data transceiver 112 references network connection information returned from consulting the operating system 100a. Since the network connection information includes a connection IP address and connection type (for example, 3G mobile phone network and Wi-Fi LAN network) in case the wireless communication terminal 100 is connected to a communication network, creation of a communication socket can be requested by specifying a connection type for a communication network to be used or specifying a connection IP address associated with the communication network. In one embodiment according to the present invention, a communication socket can be created for each of a plurality of available communication networks.

The operating system 100a confirms a destination IP address of a received request compliant with communication specifications through the information carried by the request (for example, protocol information and name or IP address of a host field carried by the request), assigns a port number according to the protocol of the request, and specifies IP:Port address (in what follows, the term of “IP address” is also used to refer to include a port number) of the destination. After confirming a local IP address (IP:Port) specified by adding a port number allocated to the data transceiver 112 (depending on the needs, the data transceiver in this context can be replaced with the media player 110) which has requested creation of a communication socket to a connection IP address allocated from a default or a designated communication network, the operating system 100a establishes a TCP connection with the content server 12 by pairing the destination IP address and the local IP address. Once the TCP connection is established successfully, the operating system 100a returns the identifier of a created communication socket 22 to the data transceiver 112 in response to the request for creating a communication socket.

When the identifier of a generated communication socket 22 is returned, the data transceiver 112 transmits again the previously notified request compliant with communication specifications to the content server 12 through the communication socket 22 specified by the identifier and receives the response received previously by the browser through the newly generated communication socket 22. At this time, the request in compliance with communication specifications for transmission, for example, a content request document generated according to the HTTP syntax for the URL of “http://vod.airplug.com/vd/vABC.mp4” is stored separately for later use.

In one embodiment according to the present invention, the data transceiver 112 can modify the previously notified request compliant with communication specifications to request only the front part of the corresponding requested content and transmit the modified request to the content server 12.

In case a plurality of communication sockets are generated according to one embodiment of the present invention described above, a request compliant with communication specifications is generated for each segment of divided front part of the selected content and transmitted. At this time, the selected content is divided into segments, each of which has a predetermined size or a size determined according to the characteristics of a communication network, for example, transmission rate.

Meanwhile, the browser, at the same time of activating the media player 110, can transmit a request compliant with communication specifications for suspending transmission of the response data received by a previously generated communication socket 211 or close the communication socket 211.

The data transceiver 112 reads response data received through the communication socket 22, interprets the response data according to communication specifications, for example, HTTP or RTSP/RTP, and extracts and stores metadata required for a media file streamed according to the response. If the previously transmitted request compliant with communication specifications requests the whole content, the data transceiver 112 can suspend reception of content data following metadata by requesting the operating system 100a to release or close the communication socket 22. The extracted metadata can include media information extracted from the front part of the media file data, for example, playtime information, in addition to file description information provided according to a protocol format for media file transfer. According to one embodiment of the present invention, data received from a plurality of communication sockets generated for each of a plurality of communication networks can be combined for each data interval, and the metadata can be extracted from the combined data. Since a method for dividing content data into segments and combining the segments in their original order is the same as the method for receiving content data in an arbitrary order of segments and using the received segments in the original order, which is described in detail later, descriptions of the former method will be omitted in this document.

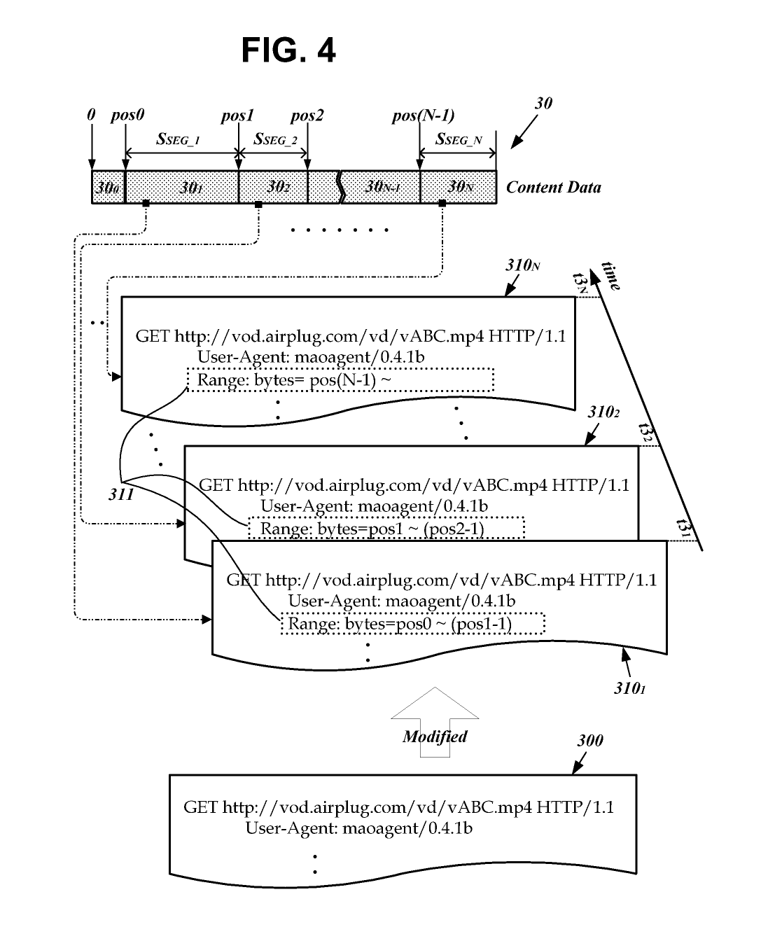

The content data segments after the segments (data received before data reception is suspended or data received from designated segments) from which metadata have been extracted are received by requesting them through a content request document revised from the stored content request document. To describe more specifically, as shown in FIG. 4, for the selected content data 30 (these data are not actual data found in the wireless communication terminal 100, but artificial data constructed from the total size of the previously confirmed content), to extract metadata as described earlier, size of a segment S_{SEG}_{_{—}}₁ to follow the segment 30₀ obtained through the initial single communication network or obtained in segments through a plurality of communication networks is determined, and a content request document 310₁ demanding a segment of the size 30₁ is generated with reference to the stored content request document 300. The content request document 310₁ demanding a specified segment contains a range field and a range value 311 specifying the corresponding interval. FIG. 4 also illustrates content request documents 310L, L=2, 3, . . . , N by which appropriate segments are specified and requested for transmission subsequently, and the size of a segment requested by the corresponding request document is determined adaptively according to reception conditions. At this time, the size of a segment requested by each request document can be determined by referring to metadata extracted and stored previously.

Also, in an embodiment of the present invention, the size S_{SEG}_{_{—}}ₖ of a segment currently requested for transmission can be determined through various ways. For example, the size can be specified by a predetermined time period or in proportion to a transmission speed of an employed communication network. Similarly, the size can be determined by a value of data size specified adaptively or can be determined from a value of a time period specified adaptively. In case the size of a segment is specified in terms of time, the segment size is determined with reference to the total size of content data and play time of the content specified in the metadata, where the segment size S_{SEG}_{_{—}}ₖ is determined by multiplying ((CS/PT)*Ts (bits)) the value (CS/PT (bits/sec.), which corresponds to a required bit rate for the corresponding content) obtained by dividing content data CS (bits) by play time of the content PT (sec.) with the adaptively specified time Ts (sec.).

Once a request document 310₁ requesting transmission of a segment 30₁ of content data subsequent to the segment 30₀ previously obtained for extraction of metadata is generated t3₁ according to the method illustrated in FIG. 4, the data transceiver 112, while providing the operating system 100a with the URL information specified in the request document 310₁, requests generation of a new communication socket in the same way as described above. According to the request, a communication socket 23 meant for a default communication network or a communication network (or connection IP address) designated at the time of request is generated, where the identifier of the communication socket 23 is returned to the data transceiver 112. Then the data transceiver 112 delivers the request document 310₁ requesting transmission of the first segment 30₁ through the specified communication socket 23 to the operating system 100a as the identifier. In case a communication socket meant for a communication network to be used currently is already generated, the request document 310₁ can be delivered to the operating system 100a through the generated communication socket. A method for using communication networks and how to select a communication network according to the method will be described in detail below. The request document delivered to the operating system 100a is transmitted to the content server 12, and accordingly, the content server 12 transmits a response compliant with communication specifications including data of a first segment 30₁ of the requested content data. The transmitted response is delivered to the data transceiver 112 through the communication socket 23 or the existing communication socket by the operating system 100a, and the data transceiver 112 reads response data received through the communication socket 23, interprets the response data according to communication specifications, for example, HTTP or RTSP/RTP, and moves segment data of a media file streamed in accordance with the response to the receiving buffer 113a in order.

The media data processing unit 111 takes out media data accumulated in the receiving buffer 113a in a sequential order through the same method as above, determines a decoding method according to encoding information of data recorded in the header of the data, and decodes the media data partially or completely according to the decoding method determined. In the case of partial decoding, the decoder 110a is also configured with the decoding method determined. The partial decoding may be, for example, extraction of media packets in units of blocks, pictures, or GoP (Group of Pictures). In case the media data are decoded partially as described above, the media data processing unit 111 requests decoding while feeding the decoded media packets to the decoder 110a, thereby outputting an image and audio signal corresponding to the decoded media packets. The image data fully decoded by the media data processing unit 111 is applied to the display driving unit 4 through the operating system 100a and output as an image signal.

The embodiment described above assumes that the media data processing unit 111 takes out media data from the receiving buffer 113a; however, in another embodiment according to the present invention, the data transceiver 112 can read out media data from the receiving buffer 113a and deliver the media data to the media data processing unit 111. In the present embodiment, when the media data processing unit 111 notifies of the need for additional media data to decode, the data transceiver 112 recognizes the need, reads out a predetermined amount of media data from the receiving buffer 113a, and delivers the media data to the media data processing unit 111. It should be noted, however, that instead of delivering actual data, an address pointing to the storage temporarily storing the data read out can be provided.

On the other hand, in the middle of outputting decoded media data by receiving media data and providing the received media data to the media data processing unit 111 as described above, the data transceiver 112 continuously monitors the communication socket 23; the amount of media data (the amount of received data for each requested interval and the total amount of received content data) received through the previously generated or newly generated communication sockets and moved to the receiving buffer 113a; traffic per hour (namely, a receiving speed; the amount of unprocessed data not provided to the media data processing unit 111 yet, namely, not taken out yet but accumulated in the receiving buffer 113a, that is, change of the amount of buffered data. According to one embodiment of the present invention, instead of the total amount of unprocessed data, the data transceiver 112 can continuously monitor the amount of unprocessed data that can be played continuously, which will be described in more detail below. In case a plurality of communication sockets are generated for the same communication network, the data transceiver 112 also monitors data traffic per hour flowing solely to the receiving buffer 113a according to the order of data segments received respectively from the plurality of communication sockets, namely, a data receiving speed for each communication network.

If media data of a segment specified by the previously transmitted request document 310₁ start to be received through the communication socket 23; media data are received by more than a predetermined ratio; or reception of the media data is completed, the data transceiver 112 determines the size S_{SEC}_{_{—}}₂ of a segment to be requested next, generates a request document 3102 demanding the segment t32, transmits the generated request document 3102 to the content server 12 through the communication socket 23 (or through another communication socket newly generated). In case the next segment is determined and requested while the media data of a segment requested by the previously transmitted request document is not completed received, the request document demanding the next segment is transmitted through a communication socket through which current segment data are received or a communication socket is newly generated and the request document demanding the next segment is transmitted through the newly generated communication socket. In the former case, no reverse reception of media data is encountered since the content server 12 receiving a request document first of all completes transmission of segment data specified by the received request document and subsequently transmits segment data in response to the received request document.

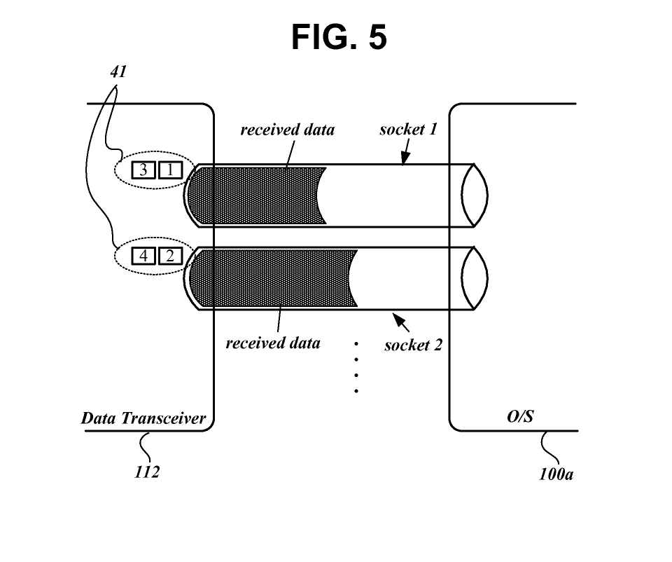

The data transceiver 112 can determine the size of a segment to be requested subsequently on the basis of the amount of buffered data in the current receiving buffer 113a. For example, in case the amount of buffered data is large, the size of a segment to be requested is set to be small but to be large in the opposite case. The process of determining the size of a segment and generating a request document demanding the next segment and transmitting the request document is carried out until all of the media data of the previously selected content are received. And at the time of transmitting the request document, the data transceiver 112 records 41 information for identifying the request document (for example, a start position of the segment requested by the request document or a serial number assigned when the request document is generated) in conjunction with a communication socket through which the request document is transmitted as illustrated in FIG. 5. According to another embodiment of the present invention, the data transceiver 112 can record a number indicating the location order of a segment in the whole data in conjunction with a communication socket transmitting the request document demanding the segment. In this way, identification information or order information recorded in conjunction with a communication socket is used to identify the order of segments of content data included in the response received respectively through the corresponding communication sockets when the request document is transmitted being divided throughout a plurality of communication sockets, and segment data received from each communication socket according to the identified order are moved to the receiving buffer 113a.

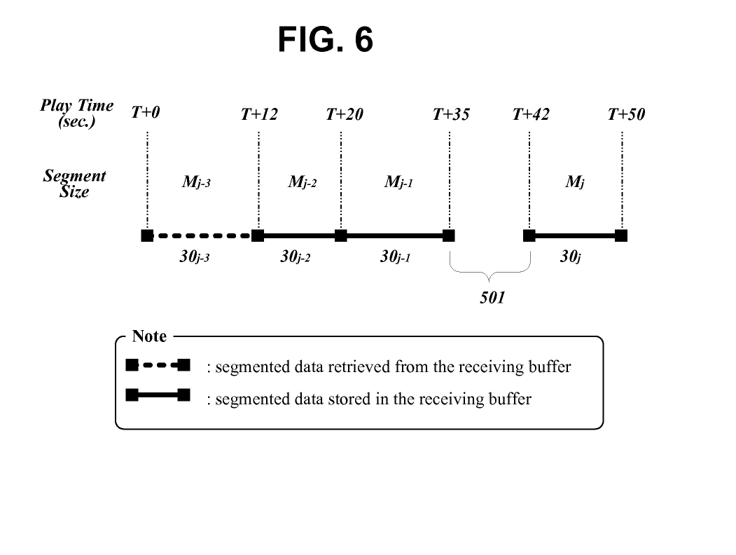

In one embodiment according to the present invention, before data of each segment are moved to the receiving buffer 113a, headers of individual packets comprising the segment data, for example, PES packets are examined to check whether the currently moving segment comes after the segment moved previously to the receiving buffer 113a and play time zone of the moving segment. Also, an operation of tracking a playtime zone for continuous play based on unprocessed data, which enables a continuous play after the current playtime, is carried out for each movement of a segment based on the play time zone checked previously with respect to the segment taken out from the current receiving buffer 113a. FIG. 6 is a simplified example to help understanding of the operation. The example of FIG. 6 illustrates that the previously moved segment is taken out by the media data processing unit 111 at the time the currently received segment 30ⱼ is moved to the receiving buffer 113a, and the currently moved segment 30ⱼ does not succeed the segment 30ⱼ₋₁ which has moved right before the currently moved segment 30ⱼ in view of playing segment data. In this case, when the segment 30ⱼ₋₃ has not taken out yet and the segment 30ⱼ has not been stored yet, the data transceiver 112 maintains continuously monitored unprocessed data to have the value of Mⱼ₋₃+Mⱼ₋₂+Mⱼ₋₁. When the segment 30ⱼ₋₃ is taken out, the continuously monitored unprocessed data are set to the value of Mⱼ₋₂+Mⱼ₋₁. And even if the segment 30ⱼ is moved to the receiving buffer 113a, the segment does not succeed the segment 30ⱼ₋₁ which has just moved to the receiving buffer; therefore, the data transceiver 112 maintains the monitored unprocessed data to have the value of Mⱼ₋₂+Mⱼ₋₁ continuously. In other words, the actual unprocessed data not taken out but remaining in the receiving buffer 113a amounts to Mⱼ₋₂+Mⱼ₋₁+Mⱼ; however, the data transceiver 112 considers the value indicating the amount of successive data Mⱼ₋₂+Mⱼ₋₁ that can be played continuously at this time point to be the amount of unprocessed data, and compares the value with reference values to be described later. Afterwards, when segment data (which has size Mⱼ₊₁) for missing part 501 are received and moved to the receiving buffer 113a, the value for the amount of monitored unprocessed data becomes Mⱼ₋₂+Mⱼ₋₁+Mⱼ+Mⱼ₊₁.

In one embodiment according to the present invention, the value specifying the total amount of unprocessed data not provided to the media data processing unit 111 yet or specifying the amount of successive unprocessed data (in what follows, unless the terms of “unprocessed amount” or “the amount of unprocessed data” are separately treated otherwise, the terms are used to denote the total amount of unprocessed data or the amount of successive unprocessed data) can be handled and managed (for example, the value can be used for comparison with reference values to be described later) in view of playtime rather than data size. The amount of continuous unprocessed data managed in the example of FIG. 6 becomes 23 seconds (=(T+35)−(T+12)).

Meanwhile, the data transceiver 112, while changing a method for using communication networks according to the number of available communication networks, condition of a currently employed communication network, or unprocessed state of the data, performs transmission of the aforementioned request document, reception of media data in accordance with the transmission, and data transfer to the receiving buffer 113a, which will be described in more detail below.

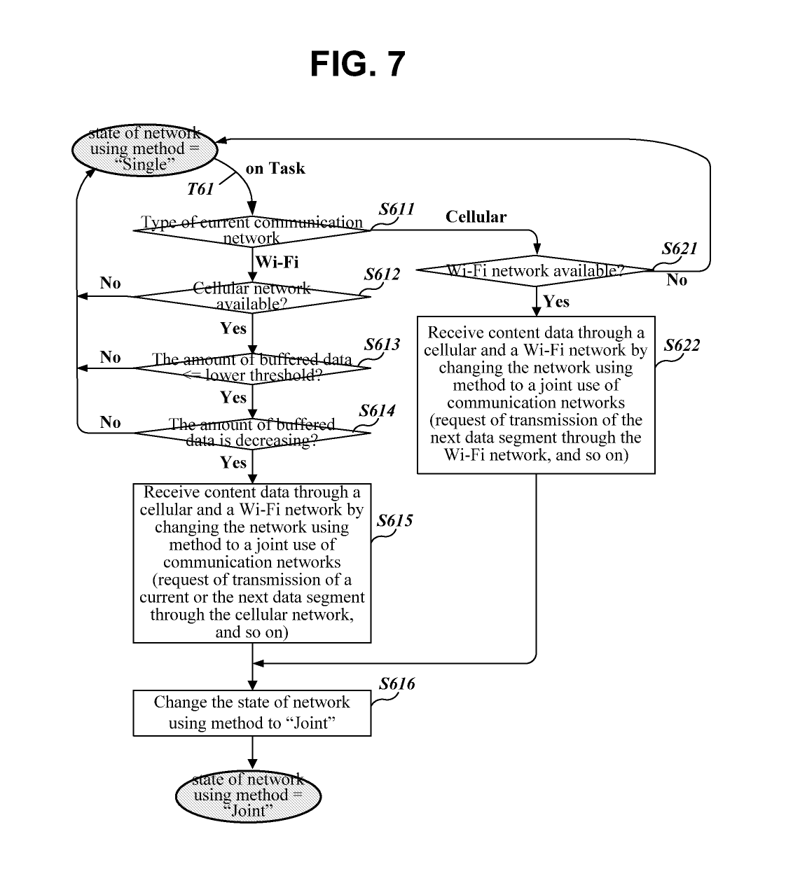

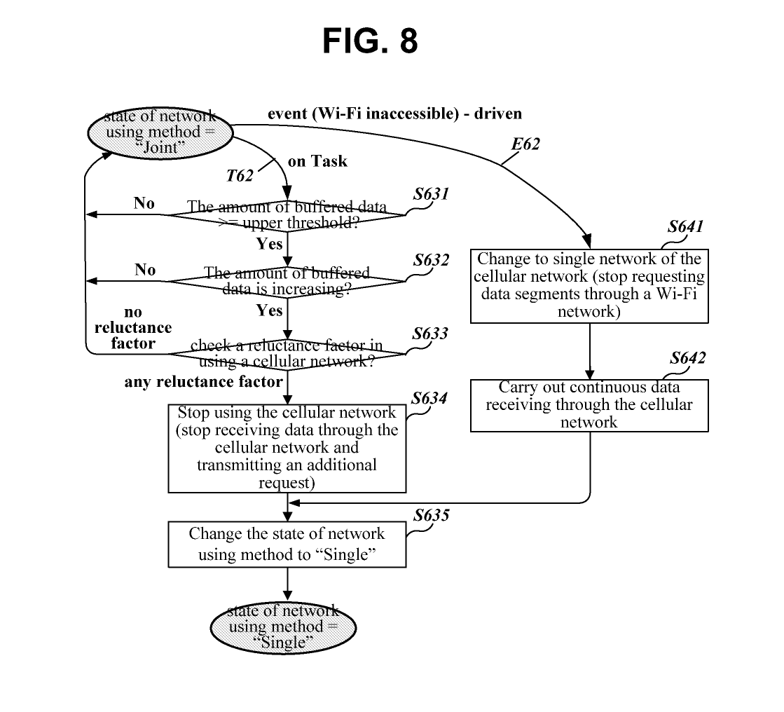

When it becomes the time for requesting a content segment, the data transceiver 112 first checks a state variable for a current “method for using communication networks” managed by the data transceiver 112. The initial value of the state variable is set to “single use” at the time of requesting reception of the initial content data. In another embodiment according to the present invention, the initial value may be set to “joint use”. The value of the state variable is intended to indicate that the operating system 100a requests data reception through one of communication networks to which the wireless communication terminal 100 is currently connected. If a current value of the checked state variable is “single use”, the data transceiver 112 actively performs T61 a selective use of communication networks according to the procedure illustrated in FIG. 7; whereas, if the value is “joint use”, the data transceiver 112 actively performs T62 a selective use of communication networks according to the procedure illustrated in FIG. 8. The individual procedures illustrated in FIGS. 7 and 8 are carried out before each of the segments subsequent to the request for the initial segment 30₁ of the selected content is requested.

First, the procedure of FIG. 7 carried out for the case where the value of a current state value is “single use” will be described. The data transceiver 112 checks the type of the communication network, for example, a cellular network or a Wi-Fi network which has generated a communication socket through which a previous request document has been transmitted S611. The type of a communication network can be known from connection type information obtained by consulting the operating system 100a before generation of the communication socket is requested.

If the communication socket which has transmitted the previous request document corresponds to a communication socket generated from a Wi-Fi network, it indicates that a current Wi-Fi network is used alone. Thus the data transceiver 112 consults the operating system 100a about availability of a cellular network S612. If a cellular network is currently unavailable, the data transceiver 112 terminates the procedure illustrated in FIG. 7 and stays in the “single use” state for using communication networks until the next execution conditions are met. At this time, the data transceiver 112 can request the operating system 100a to perform a data service connection to a cellular network.

Meanwhile, if a cellular network is available, the data transceiver 112 checks whether the amount of unprocessed data in the receiving buffer 113a, for example, the total amount of buffered data or the amount of continuous data as described above (in what follows, the phrase of “the amount of buffered data” is used to denote “the total amount of buffered data” or “the amount of continuous data”) is smaller than a lower threshold value, which is one of reference values S613. The lower threshold value can be specified in terms of data size or time (for example, 5 seconds, 7 seconds, and the like). In case the lower threshold value is specified in terms of time, the data transceiver 112 multiplies a required bit rate for playing of the corresponding content (the bit rate is actually an average speed at which the media data processing unit 111 takes out media data from the receiving buffer 113a) with the specified time to obtain the corresponding amount of data, after which the checking operation S613 is carried out. The required bit rate C_BR of the corresponding content becomes the total size of content data TD_Size specified in the previously stored metadata divided by play time P_Time of the content (C_BR=TD_Size/P_Time). Therefore, the data transceiver 112 compares a reference amount of data, which is obtained, for example, by multiplying the lower threshold value specified in terms of time T_Ref1 with the obtained required bit rate C_BR (=T_Ref1*C_BR), with the amount of unprocessed data remaining in the receiving buffer 113a. In case the amount of buffered data is managed by play time instead of data size according to one embodiment of the present invention described above, the reference amount of data is compared directly with the lower threshold value specified in terms of time.

If the amount of buffered data falls below the lower threshold value, the data transceiver 112 checks whether the current communication network, namely, Wi-Fi network, is in good conditions. In one embodiment according to the present invention, communication conditions are determined by whether the amount of buffered data remaining in the receiving buffer 113a is decreasing or not S614. For example, in case the amount of buffered data in the receiving buffer 113a monitored by the data transceiver 112 has decreased by more than a predetermined allowed range when compared with the previous value while the total amount of content data specified in the stored metadata has not been received yet, it is determined that communication conditions are not good. Similarly, the communication conditions can be determined by the magnitude of received signal strength or the amount of signal change, which can be checked by consulting the operating system 100a. For example, the operating system 100a can determine the communication conditions by reading the information provided by the Wi-Fi modem 2a at the time of detecting an effective signal in the corresponding signal band and interpreting the magnitude of the provided RSSI (Received Signal Strength Indicator) or the amount of signal change.

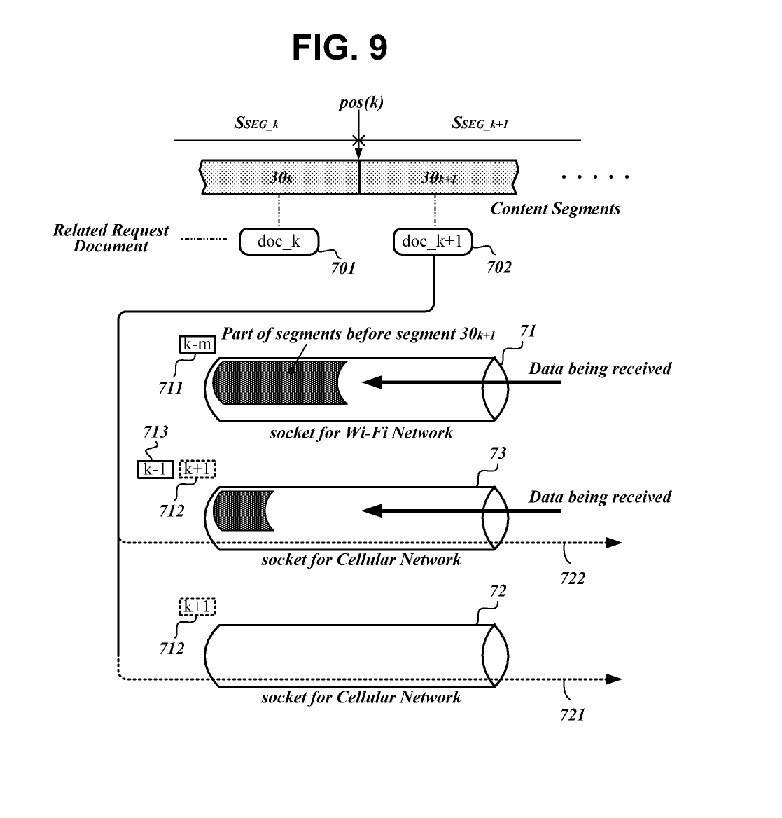

If it is determined that communication conditions are not good, the data transceiver 112 changes a method of using communication networks from using a single network to a joint use of communication networks by employing a currently connected cellular network S615. To this end, the data transceiver 112 chooses the cellular network as a communication network to receive the previously selected content and requests the operating system 100a to generate a new communication socket. Accordingly, the operating system 100a establishes a TCP connection to the content server 12 through the cellular network, generates a new communication socket related to the connection, and returns the identifier of the communication socket to the data transceiver 112. If an existing communication socket is found in the cellular network, generation of a new communication socket may not be requested. As shown in FIG. 9, the data transceiver 112 determines the size S_{SEG}_{_{—}}ₖ₊₁ of the succeeding content segment 30ₖ₊₁ (or size S_{SEG}_{_{—}}ₖ₊₁₊ₐ of a segment subsequent to the succeeding segment 30ₖ₊₁₊ₐ), generates a request document 702 demanding the segment as described above, and requests the operating system 100a to transmit the generated request document 702 through the communication socket 721 generated newly for the cellular network or through the existing communication socket 73. It should be noted that the operation of receiving content data belonging to the previous segment 30ₖ or segments 30ₖ₋ₘ preceding the previous segment passing via the Wi-Fi network through the communication socket 71 generated for the Wi-Fi network in the previous process is carried out. And the data transceiver 112 records information 712 with which a requested content segment or request document can be identified in conjunction with the communication socket 72 or 73 through which transmission request is made.

According to a transmission request of the request document 702, the request document 702 passes through a cellular network specified at the time of generating the communication socket 72 or specified by the existing communication socket 73 and is transformed to a radio signal through hardware resources of the cellular codec 1b and cellular modem 1a. The radio signal is delivered to the content server 12 through the cellular network. Accordingly, the content server 12 transmits the corresponding segment 30ₖ₊₁ (or subsequent segments 30ₖ₊₁₊ₐ) requested by the request document 702, and the data of the corresponding segment are delivered to the data transceiver 112 through the communication socket 72 or 73 by the operating system 100a. Receiving data through the communication socket 72 or 73, the data transceiver 112 checks the order of segment data received by communication sockets 71 and 73 or 71, 72 and 73 based on the segments associated with individual communication sockets or identification information 711, 712, 713 of the request documents. After the last bytes of the segment data 30ₖ are moved to the receiving buffer 113a through one of communication sockets 71 or 73, the data transceiver 112 subsequently moves data received through the newly generated communication socket 72 or the existing communication socket 73 sequentially to the receiving buffer 113a. Through this process, reception of the previously selected content data is carried out by using multiple communication networks jointly.

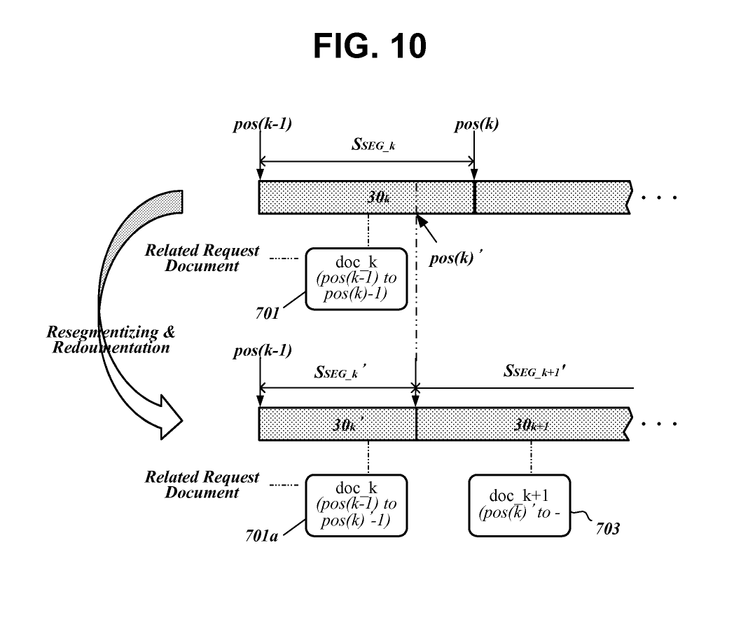

In the step of switching a method for using communication networks to “joint use” S615, the data transceiver 112 can receive the remaining data of a segment not completely received, through a newly generated communication socket for a cellular network or through the existing communication socket by adjusting previously requested data segments and revising a request document. FIG. 10 illustrates the process with an example of FIG. 9. To describe more specifically with reference to the example, at the time the method for using communication networks is set to “joint use”, the request document 701 is revised 701a by using the last position pos(k)′−1 of the segment data received by the request document 701 (the document which has requested data from pos(k−1) to pos(k)−1) transmitted through the communication socket 71 generated with respect to a Wi-Fi network. The data transceiver 112 then determines the size S_{SEG}_{_{—}}_{K+1}′ of a segment to be requested from the next position pos(k)′ (where the size may be equal to or larger than the segment ranging from pos(k)′ to pos(k)−1), generates a request document 703, and transmits the request document 703 through a newly generated or the existing communication socket with respect to the cellular network 72 or 73. Through this process, even when communication conditions of a Wi-Fi network deteriorate abruptly, the remaining data of a requested segment after current time point can be received through a relatively stable cellular network. When the data of a segment requested through a Wi-Fi network has not been received completely, the current communication network is switched to a cellular network so that the whole or part of the remaining data or a segment including the remaining data can be received through the cellular network; even after switching of the communication networks, the data transceiver 112 still properly generates individual request documents demanding data of the next segments and transmits the generated request documents through the communication socket 71 generated for the Wi-Fi network, thereby jointly using the communication networks. At this time, as for the request document using the Wi-Fi network, the requested data segment specified in the request document can be made to be short until the receiving speed through the Wi-Fi network is improved to some degree.

In another embodiment according to the present invention, the method for using communication networks can be set to a joint use based only on whether the amount of buffered data falls below the lower threshold value, without checking poor communication conditions of the current communication network as described above, for example, without performing the step of S614.

The data transceiver 112, after switching to joint use of communication networks as described above, changes the value of the state variable to “joint use” accordingly S616. While in the joint use of communication networks, the data transceiver 112 transmits individual request documents generated for the next data segments by distributing the request documents appropriately according to the amount of data received or the receiving speed through the respective communication sockets, thereby making reception of content data through multiple communication networks continued.

In the previous embodiment, checking of availability of a cellular network S612 was carried out before the conditions (which, in the procedure illustrated in FIG. 7, correspond to the case where the amount of buffered data falls below the lower threshold value and the amount of buffered data is decreasing) for joint use of communication networks are confirmed; similarly, the conditions can be checked first, and availability of the cellular network can be checked when the conditions for joint use of communication networks are satisfied.

In another embodiment according to the present invention, the method for using communication network does not change immediately even when the above conditions for joint use of communication networks are satisfied. Rather, whether use of the cellular network is permitted is first checked and joint use of communication networks is allowed only when the cellular network is permitted to be used. Whether the cellular network is permitted for use can be checked in various ways; for example, permission can be decided automatically based on the amount of data used through the corresponding communication network for time periods, a limiting value predetermined through environmental information, and size of content data. Similarly, whether the cellular network is permitted for use of data services can be determined from configuration values for allowed items within predetermined environmental information or permission control information configured by the user's input in response to inquiries made to the user.

In the method for automatically determining permission to use the cellular network as described above, the data transceiver 112 estimates or determines the amount of data used for each interval according to a rate schedule of the user by determining the amount of data used (comprising the amount of transmitted and received data) through the cellular network monitored by the operating system 100a each time the data transceiver 112 is activated (periodically after the activation). Also the data transceiver 112, based on a rate schedule configured for the communication network by the user, checks the default amount of data over which additional expense is caused and determines the amount of remaining data by deducting the amount of data used for each interval from the default amount of data. The data transceiver 112 then calculates a ratio of the default amount of data to the amount of remaining data rd_r and ratio of the remaining time period, for example, the ratio of the total number of days configured for the rate schedule to the number of days currently remaining rt_r; calculates the remainder ratio (rr=rd_r/rt_r) from the two calculated ratios; and automatically determines whether or not the cellular network is permitted based on the value of the remainder ratio rr. For example, if the remainder ratio rr is more than a particular reference value, for example, 1.0, the data transceiver 112 determines that the cellular network is permitted to be used whereas, if the value is less than 1.0, the data transceiver 112 can determine that the cellular network is not allowed for use. In another method, the data transceiver 112 compares a predetermined limit value for content size that can be handled in the cellular network with the total size of the selected content obtained from the metadata of the corresponding content. If the total size is less than the limit value, the data transceiver 112 can determine that the cellular network is permitted to be used, but not allowed for use in the opposite case.

In the exemplary method which determines permission to use data services from the configuration values for allowed items, the user configures the allowed item to be “On” or “Off” through the touch sensor 6a or keypad 6b in the environmental information setting window which contains the allowed items provided by the media player 110 on the display panel 5 through an appropriate menu screen at the time of user request. The data transceiver 112 can immediately determine permitted-or-not of the cellular network from the values configured for the allowed items within the environmental information.

In the exemplary method which determines permission to use data services from the permission control information, at appropriate time point, for example, at the time of activating the media player 110 or at the time of selecting the content, a window inquiring permission of a cellular network is displayed on the display panel 5 through the operating system 100a. A selected value taken from the window, namely the selected value about permission (“Yes”) or rejection (“No”) of the cellular network is received and set as the permission control information. As the permission control information is shared by the data transceiver 112, whether the cellular network is permitted can be determined immediately by the value of the control information. Similarly, the data transceiver 112 consults the user about permission to use the cellular network when the aforementioned conditions for a joint use of communication networks are met. The data transceiver 112 configures the permission control information according to the selection of the user and according to the value of the information, determines whether the cellular network is permitted. At this time, if no input for the inquiry is received for a predetermined time period, the data transceiver 112 may determine that the cellular network is not permitted.

Meanwhile, if the type of a communication network, where a communication socket that has transmitted the previous request document has been generated, is confirmed to be a cellular network, the data transceiver 112 checks whether a Wi-Fi network is available S621. To this end, the data transceiver 112 requests the operating system 100a to send information about the status of the Wi-Fi network. The operating system 100a, in response to the request, controls a channel search of the Wi-Fi model 2a, receives the search result, and returns the received result to the data transceiver 112. If the returned information does not have an access point, the data transceiver 112 determines that the current Wi-Fi network is not available. On the other hand, if no access point provides a signal with signal strength larger than a predetermined threshold, it is determined that the Wi-Fi network is unavailable. In case a single access point is returned, the corresponding access point is designated. In case multiple access points are available, the data transceiver 112 starts switching of a method for using communication networks by requesting the operating system 100a to choose the access point with the highest signal strength and to establish a connection to the corresponding access point. In another embodiment according to the present invention, a method for using communication networks can be kept to the single use. For example, in case the amount of buffered data exceeds a predetermined threshold, the data transceiver 112 establishes a connection to the corresponding access point and releases the connection to a previous communication network, namely the cellular network, thereby establishing a connection to the Wi-Fi network.

Once a connection to the Wi-Fi network is established, the data transceiver 112, in the same way as the process for a joint use of communication networks which employs the aforementioned cellular network additionally S615, the data transceiver 112 newly generates a communication socket for the Wi-Fi network and determines the size of a content segment to be requested for the next transmission. The data transceiver 112 then generates a document requesting the content and requests transmission of the content segment through the newly generated communication socket, thus enabling content data to be received through a joint use of communication networks S622. Since the same process for a joint use of communication networks S615 can also be used for this purpose except that a communication socket is generated for a Wi-Fi network rather than the cellular network, detailed descriptions thereof will be omitted. When a joint use of communication networks is started, the data transceiver 112 changes the state variable into “joint use” accordingly S616.

After the method for using communication networks has been changed to “joint use”, selective use of communication networks according to the procedure illustrated in FIG. 8 is carried out adaptively T62 before the next segment corresponding to the previously selected content data is requested. To begin the illustrated procedure, the data transceiver 112 first checks whether the amount of buffered data in the receiving buffer 113a exceeds a upper threshold (larger than the lower threshold), which is one of reference values S631. The upper threshold, the same as the lower threshold, can be specified in terms of size or time duration (for example, 15 seconds) of data; in case the upper threshold is specified in terms of time duration, the upper threshold is converted on the basis of reference units related to the time for the purpose of comparison. In an embodiment where the amount of buffered data is represented in units of play time, conversion of the upper threshold specified in units of time duration can be skipped and comparison can be performed immediately. If the amount of buffered data is more than the upper threshold, the data transceiver 112 checks whether the amount of buffered data is increasing S632. For example, the data transceiver 112 checks whether the amount of buffered data currently checked exceeds the amount previously checked by a predetermined amount of increase. If it is determined that the amount of buffered data is increasing, the data transceiver 112 checks whether there is a reluctance factor in an additional use of the cellular network S633. The expense to be charged according to the amount of data to be used afterwards can be one example of the reluctance factor. In other words, if it is found that a cost is additionally caused due to a data service when a confirmed cost (the cost already fixed from a data service up to the current time point regardless of additional use of a data service) is excluded, it is determined that a reluctance factor is present; in the opposite case, it is decided that no reluctance factor is present. For example, in case a price model previously chosen by the user or obtained from an external server in association with the user corresponds to “unlimited use” with respect to an appointment price for services, it can be decided that no reluctance factor is present; however, it can be decided that a reluctance factor exists in a different price model. If it is found that no reluctance factor is present for using the cellular network, the data transceiver 112 controls the method for using communication networks to operate as “joint use” and keeps performing data reception based on a joint use of multiple communication networks.

If it is found that no reluctance factor is involved in using the cellular network, the data transceiver 112 stops using the cellular network by carrying out the following operation S634. When stopping using the cellular network, the data transceiver 112 may request the operating system 100a to close all of the communication sockets generated in conjunction with the cellular network. In a different situation, the data transceiver 112 may retain the generated communication sockets by transmitting a request compliant with communication specifications requesting suspension of data transmission through a communication socket generated in conjunction with the cellular network or by ignoring data received after determining to stop data transmission.

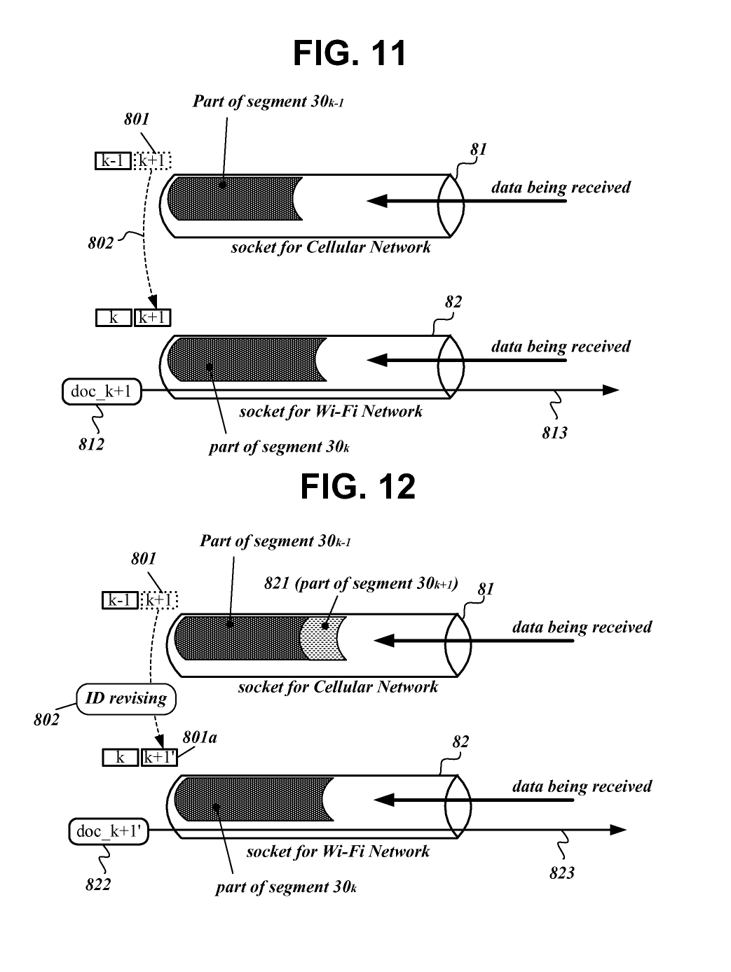

As shown in FIG. 11, if receiving a data segment 30ₖ₊₁ in response to a request document (which corresponds to “k+1” identification information 801 stored in association with the communication socket) transmitted through a communication socket 81 generated in conjunction with the cellular network has not been started yet at the time use of the cellular network is suspended, the data transceiver 112 forwards 802 identification information 801 stored in association with the not-responded request document to the different communication socket 82 generated in conjunction with the Wi-Fi network and transmits 813 the whole of the not-responded request document 812 to the different communication socket 82. As shown in FIG. 12, if the data segment 821 requested by the request document transmitted through the communication socket 81 in conjunction with the cellular network is being received, the data transceiver 112, as illustrated in FIG. 10, generates and transmits 823 a request document 822 demanding the remaining data of the corresponding segment. In this case, the data transceiver 112 modifies identification information 801 for a data segment part of which has already been received and identification information 801a stored in association with a communication socket which has transmitted a request document 822 demanding the remaining data; or modifies the request document. In an embodiment where the identification information is stored as the information for identifying a request document, the data transceiver 112 modifies a data segment specified in the request document (which corresponds to the “k+1” identification information 801) transmitted through the cellular network. On the other hand, in the embodiment in which the identification information is stored as a value representing the order of data segments, if the request document 822 requests the last data segment of current content, the data transceiver 112 modifies 802 the corresponding identification information k+1′ 801a as the next value of the identification information k+1 801 corresponding to a partly received data segment 30ₖ₊₁ and records the modified information. In case a data segment next to the data segment requested by the request document 822 has been already requested, the data transceiver 112 records the identification information k+1′ 801a as the value of identification information k+1 and modifies the identification information k+1 801 for the partly received data segment 30ₖ₊₁ to have a value lying between k and k+1. As described above, the method of modifying or assigning identification information can be applied the same for the case illustrated with reference to FIG. 10.

The data transceiver 112 may transmit a request for the next data segment or unreceived remaining data of a requested segment due to suspension of using the cellular network through a communication socket in conjunction with the Wi-Fi network after newly generating the communication socket.

In another embodiment according to the present invention, when use of a cellular network is suspended, all of the data segments previously requested through communication sockets generated in conjunction with the cellular network are received and the corresponding communication sockets are closed, or the corresponding communication sockets are not used any more for requesting data segments. In other cases, a connection to the cellular network may be released.

As described above, after use of the cellular network is suspended and the method for using communication networks is changed to “single use”, the data transceiver 112 updates the state variable indicating usage of communication networks as “single use” S635.

In a yet another embodiment according to the present invention, the step of checking variation of the amount of buffered data S632 and the step of checking presence of reluctance factors due to use of the cellular network S633 may not be carried out. In other words, if the amount of buffered data in the receiving buffer 113a exceeds the upper threshold, the data transceiver 112 may proceed directly to the step of stopping use of the cellular network S634.

Meanwhile, switching of the method for using communication networks into “single use” can be carried out passively E62 by an event generated from unavailability of a communication network, or the switching can be carried out actively T62 by the data transceiver 112. If an event preventing use of the Wi-Fi network, for example, an event such as release of a connection IP address is generated from the operating system 100a while content data is received through a joint use of communication networks, the data transceiver 112 switches the network for use to a single cellular network S641 by not processing a further request for a data segment through the Wi-Fi network. The data transceiver 112 checks a data segment requested by a request document transmitted through a communication socket generated in conjunction with the Wi-Fi network and a data segment requested by a request document transmitted through a communication socket generated in conjunction with the cellular network. And the data transceiver 112 checks the data received according to each request document. In case of need, the data transceiver 112 modifies the request document in an appropriate manner or newly generates a request document; and transmits the request document, thereby ensuring continuous reception of data through the cellular network without data disconnection or omission S642.

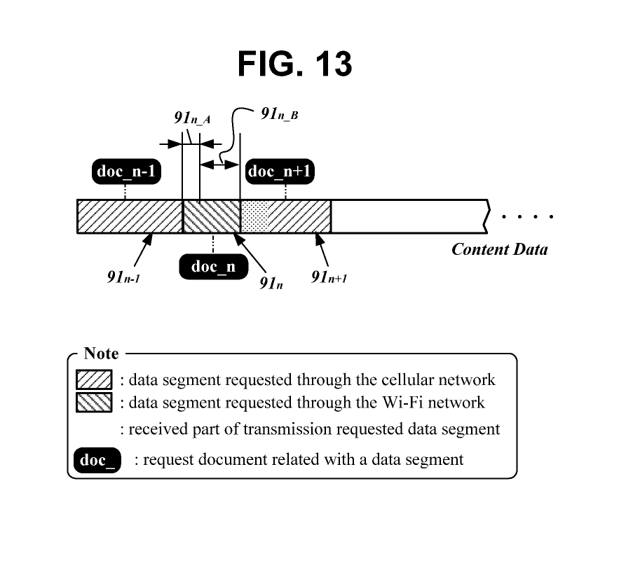

For example, as shown in FIG. 13, while part of a data segment 91ₙ requested by a request document doc_n transmitted through a current Wi-Fi network has been received, the data transceiver 112 generates a new communication socket in conjunction with the cellular network and transmits again the request document doc_n transmitted through the Wi-Fi network through the newly generated communication socket or a previously generated communication socket. At this time, all of the communication sockets generated in conjunction with the Wi-Fi network can be closed, and data segment 91ₙ_{_{—}}_{A} received partially through the Wi-Fi network can be discarded and received again through the cellular network. In a different case, the same as the example of FIG. 12 where part of a data segment received through the cellular network is used in case the use of the cellular network is suspended, the data segment 91ₙ_{_{—}}_{A} already received through the Wi-Fi network can be used effectively by transmitting a request document demanding the remaining data segment 91ₙ_{_{—}}_{B} through the cellular network.

According to the request document transmitted as described above, segment data received through each communication socket generated in conjunction with the cellular network are moved to the receiving buffer 113a in an order based on the segment associated with the corresponding communication socket or identification information of the corresponding request document. Thus, continuous downloading of content data is carried out in spite of abrupt release of connection to the Wi-Fi network.

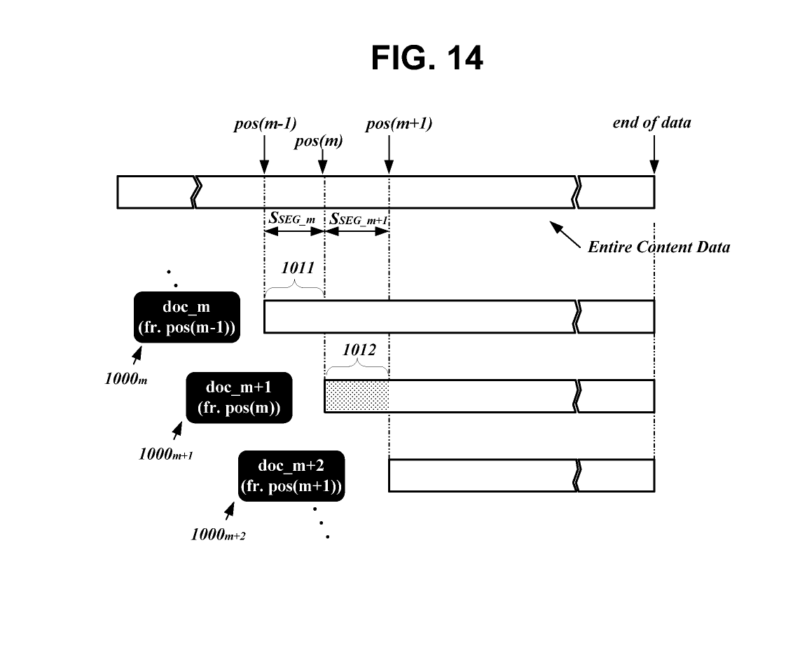

In the embodiments described above, the data transceiver 112 generates a request document specifying the start and end of a data segment from selected content and transmits the request document to the content server 12, thereby making the content data received by individual data segments. In another embodiment according to the present invention, however, the same content data can be received by individual data segments by transmitting a request document specifying only the start of each data segment. FIG. 14 is intended to help understanding of the embodiment illustrating the method above. As illustrated in FIG. 14, each request document 1000ₘ, 1000ₘ₊₁, 1000ₘ₊₂ is generated and transmitted so that it includes only the information specifying the start point of transmission or includes information about the start and end point of target content. In case a request document is generated and transmitted as described above, as illustrated in the figure, the data transceiver 112, to receive a data segment of an arbitrary size S_{SEG}_{_{—}}ₘ through a first communication network (for example, cellular network) and receive the next data segment of an arbitrary size S_{SEG}_{_{—}}ₘ₊₁ through a second communication network (for example, Wi-Fi network), transmits one request document 1000ₘ specifying only the start point pos(m−1) through the cellular network. If as much data as the intended size S_{SEG}_{_{—}}ₘ 1011 starting from the specified position pos(m−1) of the content data is received through the communication network, the data transceiver 112 can stop transmission through the communication network or close the corresponding communication socket, after which a different request document 1000ₘ₊₁ specifying only start positions is transmitted through the Wi-Fi network. Next, if as much data as the intended size S_{SEG}_{_{—}}ₘ₊₁ 1012 is received again, the data transceiver 112 stops receiving data and requests data reception through the same communication network or a different communication network by using a different request document 1000ₘ₊₂ for the subsequent data segments. According to the method described above, the previously selected content data are divided into segments and received through multiple networks. The method according to the present embodiment can also be applied to the case of using a single communication network.

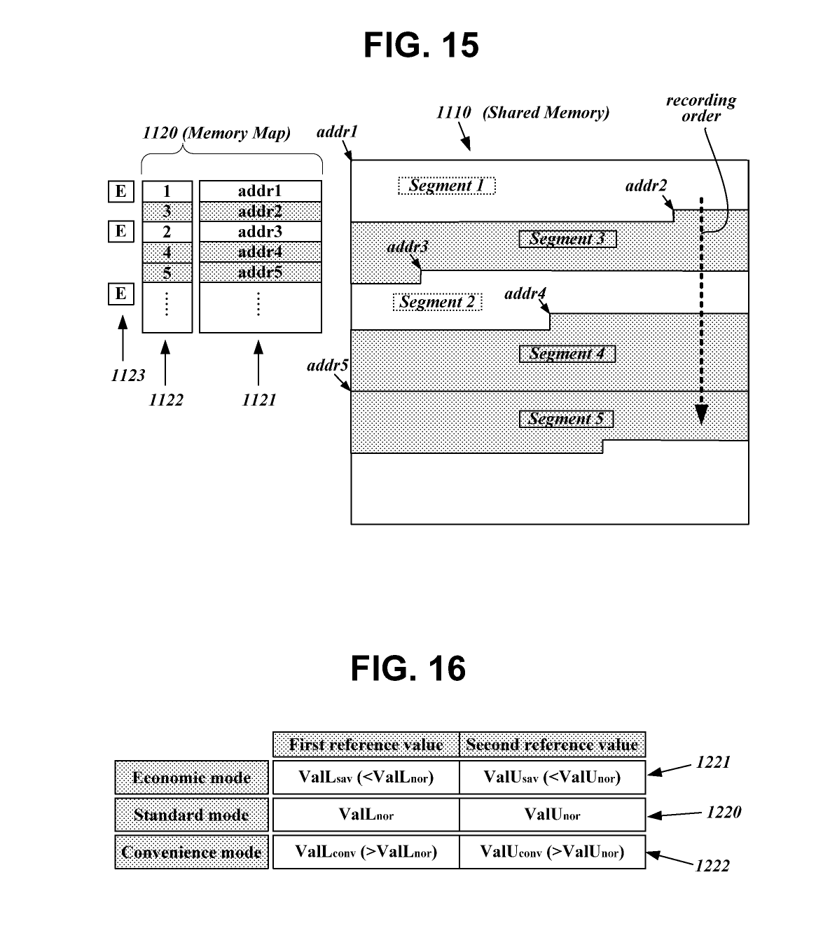

Also, in the description of the embodiments above, as an example of a data channel to and from the media data processing unit 111, a buffer storing media data in the order of segments is used. In another embodiment according to the present invention, a shared memory space can be used for the data channel. As illustrated in FIG. 15, instead of recording content data in the shared memory space according to the order of data segments, the data transceiver 112 moves a data segment to the shared memory space 1110 according to the order the data segment is received through communication sockets and stores the data segment therein. Next, the data transceiver 112 can provide the content data or let the content data taken out to the media data processing unit 111 by applying a method of specifying an order of data segments 1122 to the moved data segments. In the present embodiment, too, the amount of unprocessed data in the shared memory space is checked from the amount of data not provided to the media data processing unit 111 or from the amount of data unread by the media data processing unit 111 (or the amount of data having continuous play time). The example of FIG. 15 shows the case where data segments, the order of which is 1, 2, 3, 4, 5 within the content data requested through communication sockets by the operating system 100a, are received in the order of 1, 3, 2, 4, 5 and stored in the shared memory space according to the order the data segments are received; and the order of data segments within the content data 1122 is stored in a memory map 1120 along with storage addresses 1121 of the respective data segments. The example of FIG. 15 shows that according to the order of data segments 1122, the data segment stored thirdly (Section 2) is taken out or provided to the media data processing unit 111 before the data segment stored secondly. The order of data segments 1122 stored in the shared memory space represents the values recording the order of data segments that can be checked from the information (identification information of a request document or an order of data segments) stored in association with the respective communication sockets. Each storage address element of the memory map 1120 carries information 1123 indicating that the data segment at the corresponding address is empty after the corresponding data have been taken out by or provided to the media data processing unit 111. Then the corresponding storage address element can be used again by the data transceiver 112. In a different method, the memory map 1120 assumes a cycling buffer structure utilizing an input and output pointer and thus may not employ the indication information 1123.

Meanwhile, the data transceiver 112 configures or adjusts the lower threshold and upper threshold according to a current communication condition or a predetermined condition at the time of initial activation, before actively carrying out T61 or T62 a selective use of the communication network illustrated in FIG. 7 or 8, or right before comparing the lower threshold or upper threshold with the amount of buffered data. In the follows, a detailed description thereof will be provided.

The data transceiver 112 configures the lower and upper threshold differently according to the mode supported by a communication network use policy. Configuration of the thresholds is carried out at the initial activation of the data transceiver 112 or upon receiving a request for transmission of new content. In case the mode is changed during execution, the thresholds are changed accordingly. For description of the aforementioned case, described in the first place will be the mode according to a communication network use policy applied to the wireless communication terminal 100.

Various types of mobile communication networks utilizing different infrastructures apply different communication service rate schedules to the users depending on service provision policies of the respective service providers. For example, a data service based on a cellular network usually assumes a default amount of data within a standard rate schedule and charges additional costs in case the amount of data used exceeds the default amount of data, and the data service is provided free of charge in the case of using a Wi-Fi network. Therefore, depending on a rate schedule to which the user subscribes, the user has to pay additional charges in addition to the standard charges in case the user continuously use the cellular network which guarantees availability of data services relatively enough.

In this regard, in an embodiment according to the present invention, special modes are defined, which are used to specify which aspect is given a more weight between incurrence of cost due to using a data service and availability of the data service in selecting a communication network for using a data service. Included in the modes are an “economic mode” meant to restrain incurrence of additional cost, “convenience mode” which puts a high priority on the user convenience, for example, availability of a data service, and “standard mode” compromising restraint of cost incurrence and user convenience. The media player 110 suggests the illustrated modes through a user interface of the wireless communication terminal 100 at the time of the initialization or selecting new content and receives one mode selected by the user and notifies the data transceiver 112 about the selected mode.

In case the notified mode is “standard mode”, the data transceiver 112 configures each of the lower and the upper threshold 1220 as illustrated in FIG. 16. In the case of “economic mode”, which indicates that the user counts restraint of an incurred cost more heavily than availability of a data service, as illustrated in FIG. 16, the data transceiver 112 configures each of the lower and the upper threshold with a smaller value 1221 than that of the corresponding threshold in the case of “standard mode” 1220. If the lower threshold is set to a smaller value, the condition by which a cellular network is allowed to be jointly used while a Wi-Fi network is used alone (which corresponds to the embodiment of FIG. 7 where the step of S614 is excluded) becomes more strict; therefore, a possibility of using the cellular network is reduced compared with the case of using “standard mode”. On the other hand, if the upper threshold is set to a smaller value, the condition by which use of the cellular network is stopped and the network use is changed to the single use of the Wi-Fi network while communication networks are jointly used (which corresponds to the embodiment of FIG. 8 where the step of S632 or S633 is excluded) becomes easier to be satisfied, a possibility of stopping using the cellular network is increased compared with the case of using “standard mode”.

If the notified mode is “convenience mode”, which indicates that the user counts availability of a data service more heavily than restraint of an incurred cost due to using the data service, as illustrated in FIG. 16, the data transceiver 112 configures each of the lower and the upper threshold with a higher value 1222 than that of the corresponding threshold in the case of “standard mode”. Assigning a larger value to the lower threshold increases a possibility of jointly using the cellular network, which provides relatively higher service availability, compared with the case of “standard mode”. Similarly, assigning a larger value to the upper threshold decreases a possibility of stopping using the cellular network compared with the case of “standard mode”.

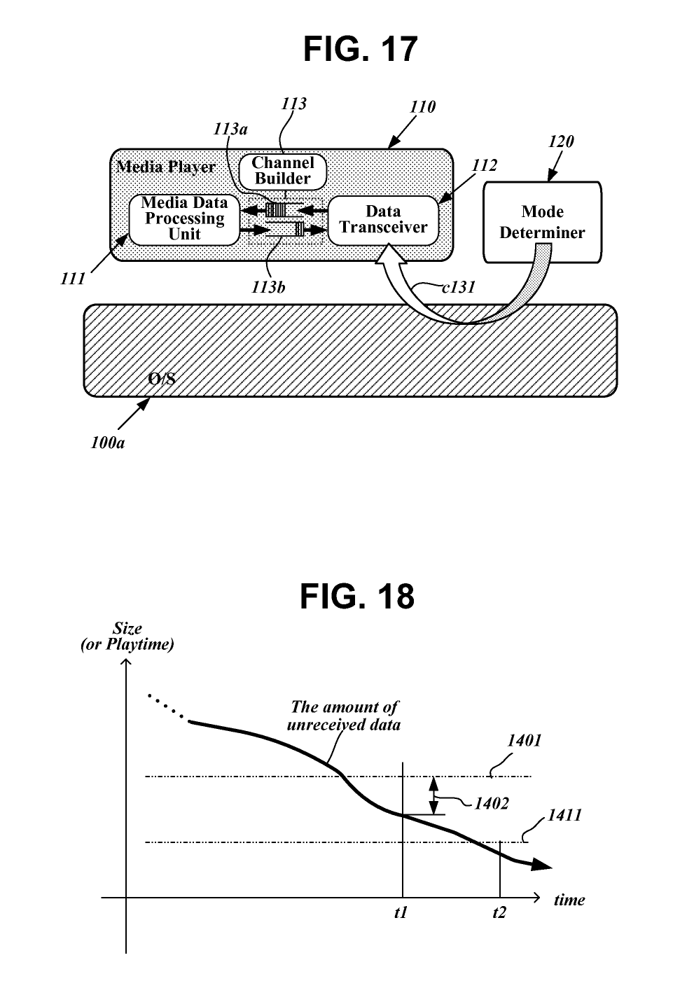

In another embodiment according to the present invention, the media player 110, instead of receiving mode configuration from the user, can read the mode assigned by a different application or process. FIG. 17 illustrates a structure related to the present embodiment; the mode determiner 120 provides the user with a menu meant for determining a mode as described above, for example, at the time screen lock of the wireless communication terminal 100 is released or at the time the user makes a request for execution; and stores the mode configured through the aforementioned process. The mode determiner 120 can help the user easily determine which mode is appropriate at a particular time point by presenting at least data usage through the cellular network and remaining days (or passed days) in terms of a rate schedule period together when the menu is provided. The stored mode value is shared by the data transceiver 112 as the media player 110 receives the mode value by requesting the mode determiner 120 to send the mode value at the time of initialization. Acquisition of the mode value from the mode determiner 120 can be carried out though a channel, which is established by the media player 110 by requesting the operating system 100a to establish the channel in conjunction with an application or process with a predetermined identifier.

The mode determiner 120 can also determine the mode automatically according to data usage for each communication network. To this end, the mode determiner 120 calculates the remainder ratio rr and determines the mode automatically according to the value of the remainder ratio rr. For example, the remainder ratio rr is less than 0.5, the mode determiner 120 determines the mode as “economic mode”; in case the remainder ratio is 1.5 or above, the mode is determined to be “convenience mode” while, if the remainder ratio is larger than 0.5 and less than 1.5, the mode is determined to be “standard mode”. In one embodiment according to the present invention, the mode determiner 120 can be incorporated into the media player 110 in the form of a sub-process or can be implemented as a separate application. In the latter case, the mode determiner 120 is activated automatically and determines one from among the aforementioned modes when a particular condition is met, for example, when the screen lock of the wireless communication terminal 100 is released or when another application requests mode information. The determined mode can be notified through a channel established between processes through the operating system 100a as described above.

In one embodiment according to the present invention which includes the mode determiner 120 determining a mode automatically in accordance with a communication network use policy, instead of calculating the remainder ratio rr directly, the data transceiver 112 requests and receives the remainder ratio rr determined by the mode determiner 120 through communication with the mode determiner 120. And the data transceiver 112 automatically determines whether it is permitted to use the cellular network as described above by using the received remainder ratio rr.

In one embodiment according to the present invention, if a Wi-Fi network is currently employed (in case the method for using communication networks is set to “joint use”, or the method is set to “single use” and a currently employed network is a Wi-Fi network), the data transceiver 112 checks the amount of data per hour received through a communication socket(s) generated in conjunction with the Wi-Fi network and moved to the receiving buffer 113a, namely monitors a data receiving speed. If the monitored receiving speed (for example, an average receiving speed for a predetermined time period) is larger than a predetermined normal speed, the data transceiver 112 reduces the lower and the upper threshold by the amount of difference between the two speed values; the data transceiver 112 increases the thresholds in proportion to the difference if the monitored receiving speed is smaller than the predetermined normal speed. At this time, the lower and the upper threshold decreased or increased may be the values set up according to a current mode. An increased receiving speed indicates a reduced chance of underrun of the receiving buffer 113a in proportion to the amount of increase; therefore, the lower threshold is reduced to make the condition for allowing a joint use of a cellular network while the Wi-Fi network is used alone more strict. Thus, the Wi-Fi network is used alone until the amount of buffered data becomes smaller than that before the lower threshold is adjusted. Similarly, the upper threshold is reduced to make the condition more easily satisfied, by which a joint use of communication networks is changed to a single use of the Wi-Fi network by stopping using the cellular network. Accordingly, the method for using communication networks can be set to the single use of the Wi-Fi network even while the amount of buffered data is smaller than that before the upper threshold is adjusted.

In another embodiment according to the present invention, the upper threshold can be adjusted according to a reduction rate of the amount of buffered data in the receiving buffer 113a. For example, if an average reduction rate for a predetermined time period is faster than a predetermined rate beyond a predetermined allowed value, the upper threshold is increased. The average reduction rate is reduced when it is slower than the predetermined rate. In the present embodiment, too, the upper threshold decreased or increased can be set according to a current mode.

In one embodiment according to the present invention, if a Wi-Fi network is currently employed, the data transceiver 112 checks current RSSI (Received Signal Strength Indicator) of an access point connected through the operating system 100a, compares the RSSI with a previous value, and calculates a variation range. If the variation range is larger than a predetermined limit, the lower and the upper threshold are increased in proportion to the difference between the variation range and the limit. At this time, the lower and the upper threshold increased may be the values set up according to a current mode. The thresholds are increased to induce a joint use of the cellular network as much as possible (in the case of the embodiment of FIG. 7 or embodiment of FIG. 7 excluding the step of S614) or to maintain the joint use of the cellular network (in the case of the embodiment of FIG. 8 or embodiment of FIG. 8 excluding the steps of S632 and S633) since an increased variation may have been caused by relative instability of the currently employed Wi-Fi network, for example, movement of the wireless communication terminal 100 or a currently connected access point, which deteriorates communication quality significantly.

In another embodiment according to the present invention, instead of variation of a signal strength value, variation of the monitored receiving speed may be used. In other words, if the variation between a current receiving speed and the previously checked one exceeds a predetermined limit, the lower and the upper threshold are increased in proportion to the variation. At this time, the lower and the upper threshold increased may be the values set up according to a current mode.

In one embodiment according to the present invention, the data transceiver 112 adjusts the lower and the upper threshold according to the amount of unreceived data of the selected content. The lower and the upper threshold adjusted may also correspond to the values set up according to a current mode. The data transceiver 112, as illustrated in FIG. 18, checks the remaining amount of unreceived data from the total amount of received data currently monitored and the total size of content data specified in the previously stored metadata; and if the amount of remaining data is below a predetermined threshold 1401 (measured at t1), decreases the lower and the upper threshold according to the difference 1402. By doing so, the data transceiver 112 can suppress the use of the cellular network as much as possible when the amount of remaining data is small. In other words, when the Wi-Fi network is used alone, a possibility of a joint use of the cellular network is reduced whereas, in the case of a joint use of communication networks, a possibility of stopping using the cellular network is increased. As illustrated in FIG. 18, in the present embodiment, if the amount of remaining data checked as described above is below a predetermined lower threshold 1411 (measured at t2), use of the cellular network may be stopped immediately at the time of the aforementioned condition is met. The stopping of using the cellular network is actually realized by setting the lower and the upper threshold to zero. Meanwhile, the threshold 1401 and the predetermined lower threshold 1411 can be configured in terms of playtime. For example, the threshold 1401 can be set to 30 seconds, and the lower threshold 1411 can be set to 10 seconds.

In one embodiment according to the present invention, the data transceiver 112 increases the lower and the upper threshold when a transmission request for a particular section of selected content is needed. At this time, the lower and the upper threshold increased may also be determined according to a current mode. The particular section can be identified by the information specified in the metadata received and stored according to the initial request for content or by the information notifying of the particular section, which is provided by a content providing server in real-time after transmission of the requested content. In the latter case, if a data segment requested by the data transceiver 112 belongs to the particular section or the data segment is located close to the particular section, the content providing server provides section description information about the particular section, for example, section indication information, type of the section, or bitrate required for the section by incorporating the section description information into a request document demanding a divided segment.

The particular section may correspond to a segment for which increase of bandwidth is required or a segment designated as a special segment due to a high preference of the users, for example, a popular segment or a segment into which additional content provided additionally by a content provider (for example, an advertisement) has been inserted. When the data transceiver 112 makes a request for transmission of content data by units of data segments as described above and the requested segment is found to belong to a particular section identified previously by metadata or a particular section identified by section description information provided in real-time, the data transceiver 112 the lower and the upper threshold. If the lower and the upper threshold are increased, a possibility of switching to a joint use of communication networks is increased in the case of a single use of a communication network. In the case of a joint use of communication networks, a possibility of staying in the same state is increased. Therefore, the data transceiver 112 can prevent a delay in receiving content data due to receiving a particular section or data reception at a receiving speed below a requested value; improve reliability of receiving data of the particular section; or accommodate the increase of required bandwidth.

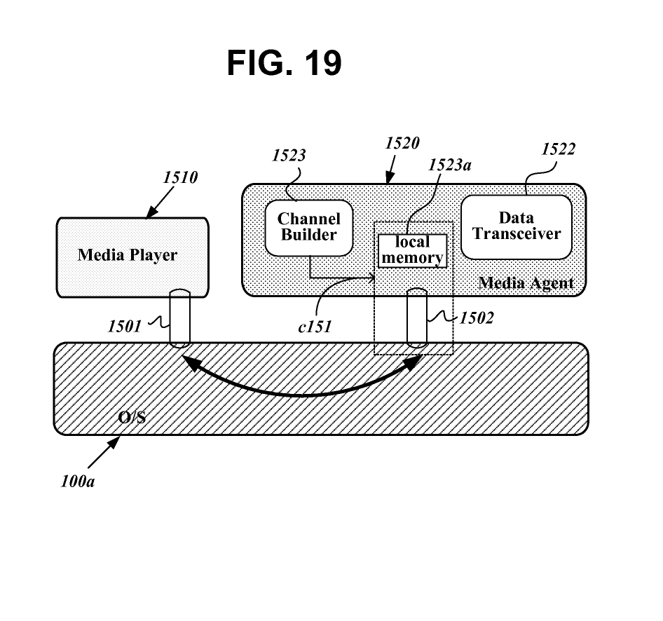

The embodiments described above assume that the data transceiver 112 and the channel builder 113 are implemented in an application for playing content, for example, a means such as a player. In another embodiment according to the present invention, however, as shown in FIG. 19, the data transceiver 1522 and the channel builder 1523 can be included in a media agent 1520 realized in the form of an object separately from a media data processor for playing content, for example, the media player 1510. The same as the media data processing unit 111 described above, the media data processor may utilize the decoder 110a for decoding of content data, which is a hardware resource of the wireless communication terminal 100. Also, the media agent 1520 performs an intended function as the main controller 10 executes command codes corresponding thereto and can be implemented in the form of an independent application, middleware, or platform. As described earlier, the media agent 1520 can include hardware components as its constituting elements. In the present embodiment, the channel builder 1523 forms c151a local memory 1523a and an internal socket 1502 to be used together as a data channel for communicating content data with the media player 1510. In other words, the channel builder 1523 allocates a storage space that can be accessed by the data transceiver 1522 in the memory 7, requests the operating system 100a to generate the internal socket 1502, and notifies the generated internal socket to the data transceiver 1522. In the same way as the aforementioned embodiments, the data transceiver 1522 temporarily stores data segments of the content received through a communication socket meant for communicating with an external server in the local memory 1523a in the order the data segments are received or along with information with which the order of the data segments can be known. Then the data transceiver 1522 reads the stored content segments according to the order thereof and provides the content segments to the media player 1510 through the internal socket 1501 in the media player 1510 generated in response to the generated internal socket 1502. Meanwhile, as for the internal socket 1502, the channel builder 1523 may form the internal socket 1502 when the operating system 100a requests generation of the corresponding internal socket according to an internal socket request of the media player 1510.

The data transceiver 1522 performs the same operation as described for the data transceiver 112 in the previous embodiments except that the media player 1510 uses a local memory 1523a and an internal socket 1502 as a data channel to deliver content data received in units of data segments. In the present embodiment, the amount of unprocessed data described in the previous embodiments is checked from the amount of data not provided to the media player 1510 from the local memory 1523a through the internal socket 1502 (or from the amount of data having continuous play time). The data transceiver 1522, in response to a request for content data from the media player 1510, compliant with communication specifications, calls for appropriate mediation of the operating system 100a. Then the data transceiver 1522 delivers segments of content data received and stored in the local memory 1523a to the media player 1510 in the order of the segments as described above or delivers information about the order of the segments to the media player 1510 together with the data segments according to a predefined method through the internal socket 1502, thereby enabling the media player 1510 to decode the data segments according to the order thereof.

In one embodiment according to the present invention, the aforementioned function implemented in the data transceiver 1520, which reads content data from the local memory 1523a in response to a request for content data from the media player 1510, compliant with communication specifications, and provides the content data to the media player 1510 through the internal socket 1502; and the aforementioned function receiving content data from an external server through the operating system 100a and storing the received content data into the local memory 1523a can be implemented as separate processes distinguished from each other.

Meanwhile, the internal socket 1501, 1502 between the media player 1510 and the media agent 1520 is generated for both applications or processes by specifying a particular IP address, for example, “127.0.0.1” or “localhost” intended to inform the operating system 100a that the particular IP address is an internal IP address; or a port number assigned to a corresponding application or process trying to generate an internal socket.

In another embodiment according to the present invention, a data channel can be implemented by an inter-process communication (IPC) method supported by the operating system 100a rather than using an internal communication socket. In this embodiment, the received data of segments are provided through IPC for the media player 1510 so that they can be decoded in the order of the data segments.

So far, the technical principles and concept of the present invention have been described in detail by using a high-speed wireless LAN network as an example of a data communication network used together with a mobile phone communication network called a cellular network for providing data services. The technical principles and concept of the present invention can be applied the same for a communication network different from the Wi-Fi network if the different communication network causes no additional charges for using a data service; or if the different communication network causes charges, not including the fixed cost described above, smaller than those of the cellular network (in other words, if a data service through the different communication network introduces smaller charges on the user) or exhibits weak service reliability due to limited availability only in a scattered, local service area of access points. Therefore, it should be understood that the technical scope defined by appended claims cannot be excluded only because a data communication network to which the present invention is applied is different from the Wi-Fi network.

The embodiments of the present invention described above have been introduced for the purpose of illustration; therefore, it should be understood by those skilled in the art that modification, change, substitution, or addition to the embodiments is possible without departing from the technical principles and scope of the present invention defined by the appended claims.

1. A wireless communication terminal, capable of accessing to a plurality of networks, comprising:
a channel builder adapted to configure a data channel for providing content data to a processing unit intended for decoding content data; and
a data transceiver adapted to
transmit a series of requests to an external server through a plurality of heterogeneous networks including at least a first communication network and a second communication network so that a selected content can be received being divided among the plurality of heterogeneous networks,
receive data of segments of the selected content transmitted through the plurality of heterogeneous networks by the external server according to the series of requests,
check amount of unprocessed data, not yet provided to the processing unit, in the data channel while providing the received data through the data channel for the processing unit to use the received data in order of segments, and
transmit a series of requests demanding data of the selected content through at least one communication network, excluding the first communication network, pertaining to the plurality of heterogeneous networks if the checked amount of unprocessed data is equal to or greater than a predetermined first reference value,
wherein the second communication network requires no cost to a user using a data service or a smaller cost, excluding fixed cost, than the first communication network.

2. The wireless communication terminal of claim 1, wherein the data transceiver is further adapted to: check the amount of unprocessed data while receiving data of segments transmitted only through the second communication network from the external server by transmitting a series of requests demanding data of the selected content only through the second communication network, and providing the received data to the processing unit through the data channel; and transmit a series of requests demanding data of the selected content also through the first communication network if the checked amount of unprocessed data is equal to or smaller than a predetermined second reference value.

3. The wireless communication terminal of claim 2, wherein the data transceiver is further adapted to: check whether use of the first communication network is permitted if the checked amount of unprocessed data is equal to or smaller than the second reference value; and transmit a series of requests demanding data of the selected content also through the first communication network only if use of the first communication network is permitted.

4. The wireless communication terminal of claim 3, wherein the data transceiver is adapted to check permission to use the first communication network based on at least one of:
a value obtained from inter-computation of remaining days on period of a rate schedule and amount of remaining data unused from a default amount of data;
a comparison result between size of the selected content and a predetermined size limit;
information within environmental information set up by a user indicating whether use of the first communication network is permitted; and
a permission control value received in response to an inquiry to a user.

5. The wireless communication terminal of claim 2, wherein the data transceiver is adapted to transmit a series of requests demanding data of the selected content also through the first communication network in case the amount of unprocessed data is equal to or smaller than the second reference value and the second communication network is not in a good communication state.

6. The wireless communication terminal of claim 5, wherein the data transceiver is adapted to determine that the second communication network is not in a good communication state if the amount of unprocessed data is decreasing.

7. The wireless communication terminal of claim 2, wherein the first reference value is larger than the second reference value.

8. The wireless communication terminal of claim 2, wherein the data transceiver is further adapted to set the second reference value to be greater than that set in a standard mode if a mode for restraining incurrence of costs is currently set, and set the second reference value to be smaller than that set in the standard mode if a mode for prioritizing convenience in using a data service is currently set.

9. The wireless communication terminal of claim 2, wherein the data transceiver is further adapted to adjust the second reference value to a smaller one if a receiving speed of data through the second communication network is higher than an arbitrary reference speed, and adjust the second reference value to a greater one if the receiving speed is lower than the arbitrary reference speed.

10. The wireless communication terminal of claim 2, wherein the data transceiver is further adapted to adjust the second reference value to a greater one if a communication characteristic of the second communication network changes larger than an arbitrary reference amount wherein the communication characteristic corresponds to at least one of a signal strength and a data receiving speed from an access point of the second communication network.

11. The wireless communication terminal of claim 2, wherein the data transceiver is further adapted to adjust the second reference value to a smaller one if amount of unreceived data of the selected content is below an arbitrary reference value.

12. The wireless communication terminal of claim 2, wherein the data transceiver is further adapted to adjust the second reference value to a greater one if request for a data segment belonging to a particular section specified with respect to the selected content is made to the external server.

13. The wireless communication terminal of claim 1, wherein the data transceiver is further adapted to adjust the first reference value to a greater one if a decrease rate of the amount of unprocessed data is higher than an arbitrary reference rate, and adjust the first reference value to a smaller one if the decrease rate is lower than the arbitrary reference rate.

14. The wireless communication terminal of claim 1, wherein the data transceiver is further adapted to set the first reference value to be greater than that set in a standard mode if a mode for restraining incurrence of costs is currently set, and set the first reference value to be smaller than that set in the standard mode if a mode for prioritizing convenience in using a data service is currently set.

15. The wireless communication terminal of claim 1, further comprising a mode determining unit adapted to automatically determine the mode based on data usage with respect to the first communication network, rate schedule information of a user, and remaining days in terms of a rate schedule period.

16. The wireless communication terminal of claim 1, wherein the data transceiver is further adapted to adjust the first reference value to a smaller one if a receiving speed of data through the second communication network is higher than an arbitrary reference speed, and adjust the first reference value to a greater one if the receiving speed is lower than the arbitrary reference speed.

17. The wireless communication terminal of claim 1, wherein the data transceiver is further adapted to adjust the first reference value to a greater one if a communication characteristic of the second communication network changes larger than an arbitrary reference amount wherein the communication characteristic corresponds to at least one of a signal strength and a data receiving speed from an access point of the second communication network.

18. The wireless communication terminal of claim 1, wherein the data transceiver is further adapted to adjust the first reference value to a smaller one if amount of unreceived data of the selected content is below an arbitrary reference value.

19. The wireless communication terminal of claim 1, wherein the data transceiver is further adapted to adjust the first reference value to a greater one if request for a data segment belonging to a particular section specified with respect to the selected content is made to the external server.

20. The wireless communication terminal of claim 19, wherein the particular section includes at least one of a segment requiring increase of bandwidth, a segment designated to have a high viewer preference, and a segment into which an additional content has been inserted.

21-22. (canceled)

23. The wireless communication terminal of claim 1, wherein the data transceiver is further adapted to transmit a series of requests demanding data of the selected content through at least one communication network, excluding the first communication network, pertaining to the plurality of heterogeneous networks if amount of unreceived data of the selected content is below an arbitrary reference value.

24-36. (canceled)

37. A method for receiving content data by using a plurality of communication networks and making the content data be played, the method comprising:
transmitting a series of requests to an external server through a plurality of heterogeneous networks including at least a first communication network and a second communication network so that a selected content can be received being divided among the plurality of heterogeneous networks;
receiving data of segments of the selected content transmitted through the plurality of heterogeneous network by the external server according to the series of requests, and providing the received data through a data channel so that a processing unit intended for decoding content data can use the received data in an order of segments; and
checking amount of unprocessed data, not yet provided to the processing unit, in the data channel and transmitting a series of requests demanding data of the selected content through at least one communication network, excluding the first communication network, pertaining to the plurality of heterogeneous networks if the checked amount of unprocessed data is equal to or greater than a predetermined first reference value,
wherein the second communication network requires no cost to a user using a data service or a smaller cost, excluding fixed cost, than the first communication network.

38. The method of claim 37, further comprising:
receiving data of segments transmitted only through the second communication network from the external server by transmitting a series of requests demanding data of the selected content only through the second communication network, and providing the received data to the processing unit through the data channel; and
checking the amount of unprocessed data and transmitting a series of requests demanding data of the selected content also through the first communication network if the checked amount of unprocessed data is equal to or smaller than a predetermined second reference value.

39. (canceled)

40. An apparatus equipped with a storage storing for programs, comprising:
communication means being capable of transceiving data with an outside entity; and
storing means storing an application to be run on a wireless communication terminal, the application being transmitted through the communication means,
wherein the application includes a program structure to accomplish operations, in case of being run on the wireless communication terminal, that comprise:
configuring a data channel;
transmitting a series of requests to an external server through a plurality of heterogeneous networks including at least a first communication network and a second communication network so that a selected content can be received being divided among the plurality of heterogeneous networks;
receiving data of segments transmitted through the plurality of heterogeneous network from the external server according to the series of requests, and transmitting the received data through the configured data channel so that a processing unit intended for decoding content data can use the received data in order of segments; and
checking amount of unprocessed data, not yet provided to the processing unit, in the data channel and transmitting a series of requests demanding data of the selected content through at least one communication network, excluding the first communication network, pertaining to the plurality of heterogeneous networks if the checked amount of unprocessed data is equal to or greater than a predetermined first reference value,
wherein the second communication network requires no cost to a user using a data service or a smaller cost, excluding fixed cost, than the first communication network.

41. The apparatus of claim 40, wherein the application further includes another program structure to accomplish operations, in case of being run on the wireless communication terminal, that comprise:
receiving data of segments transmitted only through the second communication network from the external server by transmitting a series of requests demanding data of the selected content only through the second communication network, and providing the received data through the data channel; and
checking the amount of unprocessed data, not provided to the processing unit, in the data channel and transmitting a series of requests demanding data of the selected content also through the first communication network if the checked amount of unprocessed data is equal to or smaller than a predetermined second reference value.

42. (canceled)
